(19) United States
(12) Patent Application Publication
(10) Pub. No.: US 2020/0130356 A1
(43) Pub. Date: Apr. 30, 2020

(54) LIQUID ABSORBING MEMBER AND LIQUID REMOVAL METHOD, IMAGE FORMING METHOD AND IMAGE FORMING APPARATUS EACH USING LIQUID ABSORBING MEMBER

(71) Applicant: CANON KABUSHIKI KAISHA, Tokyo (JP)

(72) Inventors: Tatsuaki Orihara, Tokyo (JP); Kenji Shinjo, Yokohama-shi (JP)

(21) Appl. No.: 16/722,801

(22) Filed: Dec. 20, 2019

Related U.S. Application Data
(63) Continuation of application No. PCT/JP2018/024803, filed on Jun. 29, 2018.

(30) Foreign Application Priority Data
Jun. 30, 2017 (JP) 2017-129725

(51) Int. Cl. B41J 2/165

(52) U.S. Cl. CPC B41J 2/16517

(57) ABSTRACT

Provided are: a liquid absorbing member configured to remove at least part of a liquid component contained in an ink image applied to a printing medium or a transfer body by being brought into contact with the ink image, the liquid absorbing member containing a hydrophilic and oil-repellent material in at least part of a surface thereof that is to be brought into contact with an ink; and an image forming apparatus including the liquid absorbing member. Also provided are a liquid removal method and an image forming method each using the liquid absorbing member.

### CROSS-REFERENCE TO RELATED APPLICATIONS

This application is a Continuation of International Patent Application No. PCT/JP2018/024803, filed Jun. 29, 2018, which claims the benefit of Japanese Patent Application No. 2017-129725, filed Jun. 30, 2017, both of which are hereby incorporated by reference herein in their entirety.

### BACKGROUND OF THE INVENTION

### Field of the Invention

The present disclosure relates to a liquid absorbing member and a liquid removal method, an image forming method and an image forming apparatus each using a liquid absorbing member.

### Description of the Related Art

In an image forming method based on a liquid-based printing system typified by an ink jet printing system, an image is formed by directly or indirectly applying a liquid composition (ink) containing a coloring material and the like onto a printing medium, such as paper. In this case, curling or cockling may occur owing to excessive absorption of a liquid component in the ink by the printing medium.

In order to quickly remove the liquid component in the ink, there have been proposed a method involving drying the printing medium by using hot air, infrared light or the like, and a method involving forming an image on a transfer body and then similarly drying the liquid component contained in the image on the transfer body, followed by transfer of the image onto the printing medium, such as paper. In addition, there is also a proposal of a method involving bringing a liquid absorbing member made of a porous body or the like into contact with an ink image to absorb and remove the liquid component from the ink image without using thermal energy. In this case, there is a concern that a component to be left on the printing medium, such as the coloring material, may be removed together with the liquid component.

In view of the foregoing, in Japanese Patent Application Laid-Open No. 2001-179959, there is a proposal of arranging a release member on a surface of the liquid absorbing member.

In the method of Japanese Patent Application Laid-Open No. 2001-179959, removal of the component to be left on the printing medium, such as the coloring material, can be alleviated, but at the same time, there is a concern that the liquid component to be removed may also become difficult to remove from the ink image.

The present disclosure has been made in view of the above-mentioned problem. It is an object of one aspect of the present disclosure to provide a liquid absorbing member capable of satisfactorily removing a liquid component in an ink image, which is to be removed, while alleviating removal of a solid component, a dissolved component or a composition obtained therefrom in the ink image, which is to be left on a printing medium or a transfer body. It is an object of another aspect of the present disclosure to provide a liquid removal method, an image forming method and an image forming apparatus each using the liquid absorbing member.

### SUMMARY OF THE INVENTION

The above-mentioned objects are achieved by a liquid absorbing member and a liquid removal method, an image forming method and an image forming apparatus each using the liquid absorbing member, according to aspects of the present disclosure.

That is, one aspect of the present disclosure relates to a liquid absorbing member for an image forming apparatus, the liquid absorbing member including a hydrophilic and oil-repellent material in at least part of a surface thereof.

In addition, one aspect of the present disclosure relates to a liquid removal method including removing at least part of a liquid component contained in an ink image formed on one of a printing medium and a transfer body by bringing the liquid absorbing member into contact with the ink image.

In addition, one aspect of the present disclosure relates to an image forming method including: applying an ink to a printing medium to form an ink image; and removing at least part of a liquid component contained in the ink image by bringing the liquid absorbing member into contact with the ink image.

In addition, one aspect of the present disclosure relates to an image forming method including: applying an ink to a transfer body to form an ink image; removing at least part of a liquid component contained in the ink image by bringing the liquid absorbing member into contact with the ink image; and transferring the ink image from which at least part of the liquid component has been removed, from the transfer body onto a printing medium.

In addition, one aspect of the present disclosure relates to an image forming apparatus including: an ink applying device configured to form an ink image on a printing medium; and a liquid absorbing device including the liquid absorbing member.

In addition, one aspect of the present disclosure relates to an image forming apparatus including: a transfer body; an ink applying device configured to form an ink image on the transfer body; a liquid absorbing device including the liquid absorbing member; and a transfer device configured to transfer the ink image from the transfer body onto a printing medium.

Further features of the present invention will become apparent from the following description of exemplary embodiments with reference to the attached drawings.

### BRIEF DESCRIPTION OF THE DRAWINGS

FIG. 1 is a schematic view for illustrating an example of the configuration of a transfer type ink jet printing apparatus according to one aspect of the present disclosure.

FIG. 2 is a schematic view for illustrating an example of the configuration of a direct drawing type ink jet printing apparatus according to one aspect of the present disclosure.

FIG. 3 is a block diagram for illustrating a control system for the entirety of each of the ink jet printing apparatus illustrated in FIG. 1 and FIG. 2.

FIG. 4 is a block diagram of a printer controller in the transfer type ink jet printing apparatus illustrated in FIG. 1.

FIG. 5 is a block diagram of a printer controller in the direct drawing type ink jet printing apparatus illustrated in FIG. 2.

### DESCRIPTION OF THE EMBODIMENTS

A liquid absorbing member and a liquid removal method, an image forming method and an image forming apparatus each using the liquid absorbing member, according to one aspect of the present disclosure, are described in detail below. However, configurations, structures, materials, settings and the like should be changed as appropriate for various conditions under which the invention is applied, and are not intended to limit the scope of the present disclosure.

The liquid absorbing member according to one aspect of the present disclosure is a liquid absorbing member for an image forming apparatus, configured to remove at least part of a liquid component contained in an ink image formed of an ink applied to a printing medium or a transfer body by being brought into contact with the ink image. As a base material for the liquid absorbing member, there are given, for example, an organic, inorganic or organic-inorganic hybrid porous body, fibers and a polymeric water absorbent material. The compositions/structures of the surface and inside of the base material may be identical to each other without being particularly distinguished, or may be different from each other in accordance with functions. A base material having pores that a liquid can permeate or percolate, such as a porous body or fibers, preferably has a pore diameter substantially equal to or smaller than the size of a solid component, a dissolved component or a composition obtained therefrom in the ink to be left on the printing medium or the transfer body (hereinafter referred to as content to be released). Meanwhile, when the pore diameter is excessively small, the flow resistance of the liquid is increased, and hence it is also preferred that the ink be designed so as to, for example, aggregate the solid component in the ink, precipitate the dissolved component, or polymerize the dissolved component, to thereby, for example, increase the size thereof or increase the viscosity thereof.

The shape of the liquid absorbing member is preferably such a shape that, after being brought into contact with an ink image once, the liquid absorbing member can circulate to be brought into contact therewith again to perform liquid absorption. Examples thereof include the shapes of a belt, a drum and the like. In addition, at the time of the contact with the ink image, the liquid absorbing member may absorb the liquid by using a capillary force or affinity for a material as a driving force with little pressing, or may, for example, be pressed to apply an action of pushing the liquid into pores.

<Hydrophilic and Oil-Repellent>

Wettability between a solid and a liquid may be generally represented with the surface free energy of the solid and the surface tension of the liquid. As the surface free energy reduces and as the surface tension increases, the liquid is more repelled on the solid, and hence the wettability reduces. For example, PTFE, which is a typical material having small surface free energy, shows a property called a “water-repellent and oil-repellent property,” which repels both water and oil. In the case of this material, the surface tension of water is larger than that of oil, and hence the following is satisfied: contact angle with water>contact angle with oil. Meanwhile, polyethylene terephthalate (PET), which has somewhat large surface free energy, shows a property called “hydrophilicity” (often not particularly called lipophilicity), which causes wetting with both water and oil. Also in the case of this material, the surface tension of water is larger than that of oil, and hence the following is satisfied: contact angle with water>contact angle with oil.

The liquid absorbing member according to one aspect of the present disclosure uses a material having a hydrophilic and oil-repellent property (hereinafter referred to as hydrophilic and oil-repellent material) in at least part of a surface thereof to be brought into contact with an ink image. The term “hydrophilic and oil-repellent property” refers to a property of having both wettability with respect to water and liquid-repellency with respect to oil. In extreme cases, some hydrophilic and oil-repellent materials are found to even satisfy the following: contact angle with water<contact angle with oil. In this connection, n-hexadecane or the like is often used for the evaluation of the contact angle with oil. The difference between the contact angles is preferably larger because an ability to separate the liquid component and the content to be released from each other is improved. In addition, the contact angle with water is preferably smaller because an ability to remove the liquid component in the ink image is improved, and the contact angle with water is more preferably 90° or less because an ink solvent is spontaneously absorbed by virtue of a capillary force. The contact angle with water is still more preferably 60° or less because cos θ (“θ” represents the contact angle), which is related to wetting and determines the capillary force and the like, becomes 0.5 or more, resulting in a remarkable capillary force. In addition, the contact angle with oil is preferably larger because an ability to release the content to be released is improved. Oil has a small surface tension, and hence, in general, the contact angle with oil is often smaller than the contact angle with water. Therefore, a material having a contact angle with oil of 30° or more may be said to be useful in practical use and to have oil-repellency. In one aspect of the present disclosure, a property of showing a contact angle with water of 90° or less and a contact angle with n-hexadecane of 30° or more is defined as the “hydrophilic and oil-repellent property,” and a material having the hydrophilic and oil-repellent property is defined as the “hydrophilic and oil-repellent material.”

The contact angle described herein is a so-called static contact angle, and may be measured with a general contact angle meter of a system involving dropping a liquid droplet onto a substrate. However, when the substrate has permeability because of, for example, being porous, it may be difficult to measure the contact angle. In this case, the measurement is performed with a flat plate made of the material for the surface of the liquid absorbing member to be brought into contact with a liquid. However, with regard to a magnitude relationship of contact angles depending on, for example, the kind of the liquid droplet, a comparison can be sufficiently performed when there is a distinct difference in the manner of permeation. In addition, the effect of a porous structure or unevenness on a contact angle is said to be generally as follows: the contact angle is increased when the contact angle on the flat plate is 90° or more, and is decreased when the contact angle on the flat plate is 90° or less. That is, in the case where contact angles are measured on a porous body, when the contact angle with water is 90° or less or water permeates, and the contact angle with n-hexadecane is 30° or more, it is found that, also on the flat plate, the contact angle with water is 90° or less and the contact angle with n-hexadecane is 30° or more, and hence the porous body may be judged to have a hydrophilic and oil-repellent property. In addition, from the viewpoint of further improving the ability to separate the liquid component and the content to be released from each other in an intermediate image with which the liquid absorbing member is brought into contact, it is preferred that the contact angle between the hydrophilic and oil-repellent material and water be smaller than the contact angle between the hydrophilic and oil-repellent material and n-hexadecane.

The changing of a contact angle with contact time of the liquid is well known as a dynamic contact angle. A contact angle at the moment of wetting is called an advancing contact angle, and a contact angle after wetting is called a receding contact angle. In general, as the contact time becomes longer, the wettability is improved. However, for example, assuming that the liquid absorbing member is used in an image forming apparatus for ink jet or the like by being brought into contact with an ink image formed of an ink applied to a printing medium or a transfer body, a period of time for which the liquid absorbing member is brought into contact with the ink is extremely short. Therefore, an advancing contact angle with water on the contact surface of the liquid absorbing member is preferably 90° or less, more preferably 60° or less.

The dynamic contact angle described herein may be measured with a general contact angle meter corresponding to an extension/contraction method, a sliding method, Wilhelmy method or the like. However, when the substrate has permeability because of, for example, being porous, it may be difficult to measure the contact angle. In this case, the measurement is performed with a flat plate made of the material for the surface of the liquid absorbing member to be brought into contact with a liquid. As described above, however, when the advancing contact angle with water is 90° or less on the porous body, it is found that the advancing contact angle with water is 90° or less also on the flat plate.

As described above, in order to allow the liquid absorbing member according to one aspect of the present disclosure to more effectively function, wettability in a short period of time needs to be taken into consideration. This indicates a liquid absorbing method involving using a liquid absorbing member distinctly different from, for example, a simple filter to be brought into constant contact with a liquid.

The hydrophilic and oil-repellent material only needs to be contained in at least part of the surface of the liquid absorbing member to be brought into contact with an ink. The hydrophilic and oil-repellent material itself may form the base material for the liquid absorbing member, the hydrophilic and oil-repellent material may be contained as part of the base material by, for example, being kneaded thereinto, or the hydrophilic and oil-repellent material may, for example, coat the base material. In the case of, for example, incorporating the hydrophilic and oil-repellent material into the base material or coating the base material with the hydrophilic and oil-repellent material, it is appropriate to perform this so that desired characteristics may be expressed in combination with the base material, a binder, other additives and the like. Also in the case where the hydrophilic and oil-repellent material forms a mixture or a compound with another material, when the mixture or the compound has a hydrophilic and oil-repellent property, the mixture or the compound itself may also be called a hydrophilic and oil-repellent material.

(Hydrophilic and Oil-Repellent Material)

The hydrophilic and oil-repellent material is not particularly limited as long as the material has a hydrophilic and oil-repellent property. In addition, examples of hydrophilic and oil-repellent materials that may be used in one aspect of the present disclosure include ones described in the following patent documents and the like, which are encompassed in the hydrophilic and oil-repellent material according to one aspect of the present disclosure.
A hydrophilic and oil-repellent agent containing a nitrogen-containing fluorine compound disclosed in Japanese Patent No. 5879014,
a hydrophilic and oil-repellent agent that is a perfluoropolyether group-containing compound disclosed in Japanese Patent Application Laid-Open No. 2016-74830,
a hydrophilic and oil-repellent agent that is a perfluoroalkyl group-containing compound disclosed in Japanese Patent Application Laid-Open No. 2016-74828,
a fluorine-based compound having an oil repellency-imparting group and a hydrophilicity-imparting group disclosed in, for example, Japanese Patent Application Laid-Open No. 2016-64405,
a fluorine-containing copolymer obtained by copolymerizing monomers essentially containing a fluorine-containing monomer and an alkoxy group-containing monomer disclosed in Japanese Patent Application Laid-Open No. 2012-184207,
an acrylate-based copolymer formed of a fluoroalkyl-based vinyl monomer, a polyalkylene glycol-containing hydrophilic vinyl monomer and a non-polyalkylene glycol-based vinyl monomer disclosed in Japanese Patent Application Laid-Open No. 2012-12718,
a fluorine-containing copolymer obtained by incorporating a fluorine-containing monomer and an alkoxy group-containing monomer and subjecting the monomers to a copolymerization reaction disclosed in Japanese Patent Application Laid-Open No. 2012-6893,
a fluoroalkyl acrylate/polyalkylene glycol acrylate polymer obtained by copolymerizing monomers essentially containing a fluorine-containing monomer and an alkoxy group-containing monomer disclosed in Japanese Patent Application Laid-Open No. 2011-88850,
a porous film obtained by performing discharge treatment in an atmosphere in which perfluorocarbon and an oxygen-containing substance that contains an oxygen atom and is free of any of a C—H bond and a halogen atom are present disclosed in Japanese Patent Application Laid-Open No. 2008-062127,
a hybrid coating material obtained by mixing at least liquid glass and a low polymer that is an oligomer and/or a cooligomer having fluorine-containing groups at both ends disclosed in Japanese Patent Application Laid-Open No. 2007-154020,
a hydrophilic and oil-repellent processing agent formed of a copolymer of a fluorine-based vinyl monomer, a polyalkylene glycol-containing hydrophilic vinyl monomer and a non-polyalkylene glycol-based vinyl monomer disclosed in Japanese Patent Application Laid-Open No. 2006-152508,
a hydrophilic and oil-repellent processing agent characterized by being a copolymer of a fluorine-based vinyl monomer, a polyalkylene glycol-containing hydrophilic vinyl monomer and a non-polyalkylene glycol-based vinyl monomer disclosed in Japanese Patent Application Laid-Open No. 2005-330354,
a hydrophilic and oil-repellent copolymer containing a sulfone group-containing hydrophilic vinyl monomer as an essential component in addition to a fluorine-based vinyl monomer disclosed in Japanese Patent Application Laid-Open No. 2002-105433,
a hydrophilic and oil-repellent treatment agent formed of a fluorine-containing silane compound and a hydrophilic silane compound disclosed in Japanese Patent Application Laid-Open No. H05-331455, and
a fluorine-based chemisorbed monomolecular multilayer film characterized in that a molecular chain containing a fluorine atom in a side chain thereof is present disclosed in Japanese Patent Application Laid-Open No. H04-367721.

A treatment method for the base material and the like are also not particularly limited, but are described in detail in each of the patent documents.

Of the hydrophilic and oil-repellent materials, it is more preferred to incorporate a fluorine compound having: a hydrophilic group selected from an anionic group, a cation group and a zwitterionic group (betaine) at an end thereof; and a divalent organic group containing one or more bonds selected from an ether bond, an amine bond, an amide bond, an ester bond and a urethane bond in a molecular chain thereof.

Of those, it is still more preferred that the hydrophilic and oil-repellent material contain at least one fluorine compound selected from the group consisting of the following general formulae (1) to (6).

Rf1-Rfo-Rf2-X (1)

In the general formula (1), Rf1 represents a perfluoroalkoxy group having 1 to 6 carbon atoms or a fluorine atom, Rfo represents a divalent perfluoropolyether group, Rf2 represents a linear or branched perfluoroalkylene group having 1 to 20 carbon atoms, and X represents any one hydrophilic group selected from the group consisting of an anionic group, a cationic group and a zwitterionic group.

The fluorine compound represented by the general formula (1) is disclosed in Japanese Patent Application Laid-Open No. 2016-74830, and specific examples of the respective groups and exemplary compounds are all encompassed in the hydrophilic and oil-repellent material according to one aspect of the present disclosure.

Rf—R—X (2)

In the general formula (2), Rf represents a linear or branched perfluoroalkyl group having 6 to 16 carbon atoms, R represents a divalent organic group containing, in a linear or branched molecular chain, at least one bond selected from an ether bond, an ester bond, an amide bond and a urethane bond, and X represents any one hydrophilic group selected from the group consisting of an anionic group, a cationic group and a zwitterionic group.

The fluorine compound represented by the general formula (2) is disclosed in Japanese Patent Application Laid-Open No. 2016-74828, and specific examples of the respective groups and exemplary compounds are all encompassed in the hydrophilic and oil-repellent material according to one aspect of the present disclosure.

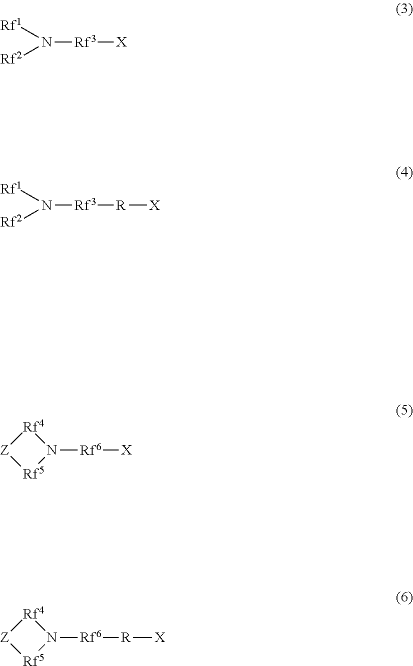

In the general formulae (3) and (4), Rf¹ and Rf² are identical to or different from each other and each represent a linear or branched perfluoroalkyl group having 1 to 6 carbon atoms, and Rf³ represents a linear or branched perfluoroalkylene group having 1 to 6 carbon atoms. In the general formulae (5) and (6), Rf⁴, Rf⁵ and Rf⁶ are identical to or different from each other and each represent a linear or branched perfluoroalkylene group having 1 to 6 carbon atoms, and Z is selected from a divalent oxygen bond, a nitrogen bond having a substituent, a CF₂ group and a CF group having a substituent. In addition, when Z contains a nitrogen atom or a CF group, a perfluoroalkyl group branching from Z may be bonded to the Z. In addition, in the formulae (4) and (6), R represents a divalent organic group containing, in a linear or branched molecular chain, at least one selected from an ether bond, an ester bond, an amide bond and a urethane bond. In addition, in the formulae (3) to (6), X represents any one hydrophilic group selected from the group consisting of an anionic group, a cationic group and a zwitterionic group.

The fluorine compounds represented by the general formulae (3) to (6) are disclosed in Japanese Patent Application Laid-Open No. 2016-64405 and Japanese Patent No. 5879014, and specific examples of the respective groups and exemplary compounds are all incorporated herein.

In order to simultaneously express excellent hydrophilicity and oil-repellency, it is preferred that a structure showing oil-repellency and a structure showing hydrophilicity be densely arranged. To that end, it is presumably important to have a compact structure. In addition, it is considered that, by adopting a branched structure or a cyclic structure rather than a linear fluorinated alkyl group or forming a link with a bonding group, such as an ether bond, an ester bond, an amide bond and a urethane bond, in a molecular chain, the oil-repellent structure is further made compact, with the result that the structure showing oil-repellency and the structure showing hydrophilicity can be made dense. In addition, it is considered that, when a divalent organic group other than a fluorinated alkyl group is linked, the divalent organic group is aligned with respect to the base material, and a hydrophilic moiety and an oil-repellent moiety are arranged on the surface in a balanced state instead of one of the oil-repellent moiety and the hydrophilic moiety being extremely exposed on the surface, and hence the hydrophilic and oil-repellent property can be simultaneously expressed.

An ion generally shows excellent hydrophilicity. This property does not particularly depend on a difference among anion, cation and zwitterion types.

(Base Material)

The base material is not particularly limited, and any of a hydrophilic material and a water-repellent material may be used. Examples of the hydrophilic material include: organic materials, such as cellulose, polyacrylamide, polyester, polycarbonate, polyamide, polyethersulfone and sodium polyacrylate; and inorganic materials, such as alumina, silica and glass fibers. In addition, the water-repellent material may be subjected to hydrophilic treatment by a method such as a sputter etching method, radiation or H₂O ion irradiation, excimer (ultraviolet) laser light irradiation or plasma irradiation. Examples of the water-repellent material include: fluororesins, such as polytetrafluoroethylene (hereinafter referred to as PTFE), polychlorotrifluoroethylene (PCTFE), polyvinylidene fluoride (PVDF), polyvinyl fluoride (PVF), a perfluoroalkoxyfluororesin (PFA), a tetrafluoroethylene-hexafluoropropylene copolymer (FEP), an ethylene-tetrafluoroethylene copolymer (ETFE) and an ethylene-chlorotrifluoroethylene copolymer (ECTFE); and polyolefins, such as polyethylene (PE) and polypropylene (PP).

Now, a case in which a porous body is used as the base material is described by giving specific examples. The contact surface of the liquid absorbing member with an ink image is defined as a first surface, and the porous body is arranged as the base material at least on the first surface.

(Porous Body)

In this embodiment, the porous body contains a hydrophilic and oil-repellent material. The porous body itself or part thereof may be formed of the hydrophilic and oil-repellent material, or the porous body serving as the base material may be coated with the hydrophilic and oil-repellent material. The average pore diameter of the porous body refers to an average diameter at the surface of the first surface or a second surface, and may be measured by a known method, such as a mercury intrusion method, a nitrogen adsorption method or SEM image observation.

When the porous body is thinned, a volume required for absorbing a liquid component cannot be sufficiently secured in some cases or mechanical performance is insufficient in some cases. Therefore, the porous body may have a multilayer configuration.

Next, an embodiment in the case where the porous body has a multilayer configuration is described. Herein, a description is made with a first layer being on a side to be brought into contact with an ink image, and a layer to be laminated on the surface of the first layer opposite to its contact surface with the ink image being defined as a second layer. Further, the multilayer configuration is also sequentially written in lamination order from the first layer.

[First Layer]

In this embodiment, a material for the first layer only needs to contain the hydrophilic and oil-repellent material, and may contain any other material as long as the effect of one aspect of the present disclosure is obtained. For example, any of a hydrophilic material having a contact angle with water of less than 90° and a water-repellent material having a contact angle of 90° or more may be used.

Examples of the hydrophilic material include: organic materials, such as cellulose, polyacrylamide, polyester, polycarbonate, polyamide, polyethersulfone and sodium polyacrylate; and inorganic materials, such as alumina, silica and glass fibers. In addition, the water-repellent material may be subjected to hydrophilic treatment by a method such as a sputter etching method, radiation or H₂O ion irradiation, excimer (ultraviolet) laser light irradiation or plasma irradiation.

In the case of the hydrophilic material, its contact angle with water is more preferably 60° or less. In the case of the hydrophilic material, the hydrophilic material has an effect of sucking up a liquid, in particular, water by a capillary force.

Examples of the water-repellent material include: fluororesins, such as polytetrafluoroethylene (hereinafter referred to as PTFE), polychlorotrifluoroethylene (PCTFE), polyvinylidene fluoride (PVDF), polyvinyl fluoride (PVF), a perfluoroalkoxyfluororesin (PFA), a tetrafluoroethylene-hexafluoropropylene copolymer (FEP), an ethylene-tetrafluoroethylene copolymer (ETFE) and an ethylene-chlorotrifluoroethylene copolymer (ECTFE); and polyolefins, such as polyethylene (PE) and polypropylene (PP).

In Examples of this embodiment, a film thickness was obtained by measuring film thicknesses at 10 random points with a straight type micrometer OMV_25 (manufactured by Mitutoyo Corporation) and calculating the average value thereof.

The first layer may be produced by a known production method for a thin porous film. For example, the first layer may be obtained by obtaining a sheet-shaped product from a resin material by a method such as extrusion molding and then stretching the sheet-shaped product to a predetermined thickness. In addition, the first layer may be obtained as a porous film by adding a plasticizer, such as paraffin, to the material for the extrusion molding and removing the plasticizer by heating or the like at the time of the stretching. The pore diameter may be controlled by appropriately adjusting the addition amount of the plasticizer to be added, a stretching ratio and the like.

[Second Layer]

In this embodiment, the second layer is preferably a layer having air permeability. Such layer may be, for example, a non-woven fabric or woven fabric of resin fibers. A material therefor is preferably selected from, for example, single materials of polyolefins (e.g., polyethylene (PE) and polypropylene (PP)), polyurethanes, polyamides, such as nylon, polyesters (e.g., polyethylene terephthalate (PET)) and polysulfones (PSF), and composite materials thereof.

[Third Layer]

In this embodiment, the porous body having a multilayer structure may have a configuration of three or more layers, and is not limited. A third layer and subsequent layers are each preferably a non-woven fabric from the viewpoint of rigidity. As a material therefor, ones similar to those for the second layer are also preferably used.

[Other Material]

The liquid absorbing member may include, in addition to the porous body of the laminated structure described above, a reinforcing member configured to reinforce the side surface of the liquid absorbing member. In addition, the liquid absorbing member may include a joining member when end portions of a porous body having an elongate sheet shape in its longitudinal direction are coupled to each other to form a belt-shaped member. A non-porous tape material or the like may be used as such material, and may be arranged at such a position or period that the material is not brought into contact with an image.

[Production Method for Porous Body]

A method of forming the porous body by laminating the first layer and the second layer is not particularly limited. The first layer and the second layer may be simply superimposed on each other, or may be bonded to each other using a method such as adhesive lamination or heat lamination. In this embodiment, heat lamination is preferred from the viewpoint of air permeability. In addition, for example, bonding lamination may be performed by melting part of the first layer or the second layer through heating. In addition, the first layer and the second layer may be subjected to bonding lamination with each other by interposing a fusing material, such as hot-melt powder, therebetween, followed by heating. When three or more layers are laminated, the layers may be laminated at once, or may be sequentially laminated, and a lamination order is appropriately selected.

In a heating step, a lamination method involving heating the porous body while the porous body is interposed and pressed between heated rollers is preferred.

In addition, a commercially available porous film may be used as the base material.

The thus formed liquid absorbing member may be suitably used for various inks. The ink is not particularly limited, but examples thereof include an ink for ink jet, an ink for flexographic printing, an ink for gravure printing, an ink for screen printing and a toner for liquid development. In addition to the foregoing, the liquid absorbing member is suitable also for various liquids including liquids for pretreatment, posttreatment and the like, such as a so-called reaction liquid for ink jet, dampening water for offset printing and a varnish for after application in various printing systems. In particular, an ink containing water as a solvent and a liquid such as a reaction liquid are suitable because the effect of the hydrophilic and oil-repellent property is high.

The solvent to be removed is not particularly limited to a main solvent, such as water, and may be a water-soluble organic solvent or the like. In addition, the content to be released is not limited to a coloring material, such as a pigment or a dye, and may be an emulsion, a water-soluble resin or the like. The solvent to be removed and the content to be released may be supplied from the same ink or liquid, or may be supplied from different kinds of inks or liquids like a reaction liquid and an ink in ink jet.

The ink for ink jet is generally required to be reduced in viscosity from the viewpoint of an ejection property, and often uses a large amount of a solvent, such as water, and hence the liquid absorbing member according to one aspect of the present disclosure may be particularly suitably used therefor. The ink for ink jet is not particularly limited, but includes such components as described below.

<Ink for Ink Jet>

Now, each constituent component of the ink for ink jet (hereinafter referred to simply as ink) to be applied to this embodiment is described in detail.

(Coloring Material)

As the coloring material, a pigment or a dye may be used. The content of the coloring material in the ink is preferably 0.5 mass % or more to 15.0 mass % or less, more preferably 1.0 mass % or more to 10.0 mass % or less with respect to the total mass of the ink.

Specific examples of the pigment may include: inorganic pigments, such as carbon black and titanium oxide; and organic pigments, such as azo, phthalocyanine, quinacridone, isoindolinone, imidazolone, diketopyrrolopyrrole and dioxazine pigments.

With regard to the mode of dispersion of the pigment, for example, a resin-dispersed pigment using a resin as a dispersant or a self-dispersing pigment in which a hydrophilic group is bonded to the particle surface of a pigment may be used. In addition, for example, a resin-bonded pigment obtained by chemically bonding an organic group containing a resin to the particle surface of a pigment or a microcapsule pigment obtained by covering the particle surface of a pigment with a resin or the like may be used.

As a resin dispersant for dispersing the pigment in an aqueous medium, one capable of dispersing the pigment in the aqueous medium through the action of an anionic group is preferably used. As the resin dispersant, such a resin as described later may be suitably used, and a water-soluble resin may be more suitably used. The content (mass %) of the pigment is preferably 0.3 times or more to 10.0 times or less in terms of mass ratio with respect to the content of the resin dispersant (pigment/resin dispersant).

As the self-dispersing pigment, one having an anionic group, such as a carboxylic acid group, a sulfonic acid group or a phosphonic acid group, bonded to the particle surface of a pigment directly or via another atomic group (—R—) may be used. The anionic group may be any of an acid type and a salt type. In the case of the salt type, the anionic group may be in any of a partially dissociated state and a completely dissociated state. When the anionic group is of the salt type, as a cation serving as a counter ion, there may be given, for example: an alkali metal cation; ammonium; and an organic ammonium. In addition, specific examples of the other atomic group (—R—) may include: a linear or branched alkylene group having 1 to 12 carbon atoms; an arylene group, such as a phenylene group or a naphthylene group; a carbonyl group; an imino group; an amide group; a sulfonyl group; an ester group; and an ether group. In addition, a group formed by combining those groups may also be adopted.

As the dye, one having an anionic group is preferably used. Specific examples of the dye may include azo, triphenylmethane, (aza)phthalocyanine, xanthene and anthrapyridone dyes.

(Resin)

The ink may contain a resin. The content (mass %) of the resin in the ink is preferably 0.1 mass % or more to 20.0 mass % or less, more preferably 0.5 mass % or more to 15.0 mass % or less with respect to the total mass of the ink.

The resin may be added to the ink for, for example, the following reasons: (i) to stabilize the dispersion state of the pigment, that is, to serve as the above-mentioned resin dispersant or an aid therefor; and (ii) to improve various characteristics of an image to be printed. Examples of the form of the resin may include a block copolymer, a random copolymer, a graft copolymer and a combination thereof. In addition, the resin may be in a state of being dissolved as a water-soluble resin in an aqueous medium, or may be in a state of being dispersed as resin particles in an aqueous medium. The resin particles do not need to include the coloring material.

In one aspect of the present disclosure, that the resin is water-soluble is defined as follows: when the resin is neutralized with an alkali in an amount equivalent to its acid value, the resin does not form particles whose particle diameters are measurable by a dynamic light scattering method. Whether or not the resin is water-soluble may be judged in accordance with the following method. First, a liquid (resin solid content: 10 mass %) containing a resin neutralized with an alkali (e.g., sodium hydroxide or potassium hydroxide) corresponding to its acid value is prepared. Subsequently, the prepared liquid is diluted 10-fold (on a volume basis) with pure water to prepare a sample solution. Then, in the case where the particle diameter of the resin in the sample solution is measured by the dynamic light scattering method, when particles having particle diameters are not measured, the resin in question may be judged to be water-soluble. In this case, measurement conditions may be set, for example, as follows: SetZero: 30 seconds, number of times of measurement: 3 and measurement time: 180 seconds. A particle size analyzer based on the dynamic light scattering method (e.g., product name: “UPA-EX150”, manufactured by Nikkiso Co., Ltd.) or the like may be used as a particle size distribution measuring apparatus. Of course, the particle size distribution measuring apparatus to be used, the measurement conditions and the like are not limited to the foregoing.

The acid value of the resin is preferably 100 mgKOH/g or more to 250 mgKOH/g or less in the case of a water-soluble resin, and is preferably 5 mgKOH/g or more to 100 mgKOH/g or less in the case of resin particles. The weight-average molecular weight of the resin is preferably 3,000 or more to 15,000 or less in the case of a water-soluble resin, and is preferably 1,000 or more to 2,000,000 or less in the case of resin particles. The volume-average particle diameter of the resin particles as measured by the dynamic light scattering method (under measurement conditions similar to those described above) is preferably 100 nm or more to 500 nm or less.

Examples of the resin may include an acrylic resin, a urethane-based resin and an olefin-based resin. Of those, an acrylic resin and a urethane resin are preferred.

As the acrylic resin, one having a hydrophilic unit and a hydrophobic unit as structural units is preferred. Of those, a resin having a hydrophilic unit derived from (meth)acrylic acid and a hydrophobic unit derived from at least one of a monomer having an aromatic ring or a (meth)acrylic acid ester-based monomer is preferred. In particular, a resin having a hydrophilic unit derived from (meth)acrylic acid and a hydrophobic unit derived from at least one monomer of styrene or α-methylstyrene is preferred. Each of those resins may be suitably utilized as a resin dispersant for dispersing a pigment because interaction between the resin and the pigment easily occurs. The hydrophilic unit is a unit having a hydrophilic group, such as an anionic group. The hydrophilic unit may be formed by, for example, polymerizing a hydrophilic monomer having a hydrophilic group. Specific examples of the hydrophilic monomer having a hydrophilic group may include: acidic monomers each having a carboxylic acid group, such as (meth)acrylic acid, itaconic acid, maleic acid and fumaric acid; and anionic monomers, such as anhydrates and salts of those acidic monomers. Examples of a cation forming the salt of the acidic monomer may include lithium, sodium, potassium, ammonium and organic ammonium ions. The hydrophobic unit is a unit free of a hydrophilic group, such as an anionic group. The hydrophobic unit may be formed by, for example, polymerizing a hydrophobic monomer free of a hydrophilic group, such as an anionic group. Specific examples of the hydrophobic monomer may include: monomers each having an aromatic ring, such as styrene, α-methylstyrene and benzyl (meth)acrylate; and (meth)acrylic acid ester-based monomers, such as methyl (meth)acrylate, butyl (meth)acrylate and 2-ethylhexyl (meth)acrylate.

The urethane-based resin may be obtained by, for example, subjecting a polyisocyanate and a polyol to a reaction with each other. In addition, the urethane-based resin may be obtained by further subjecting a chain extender to a reaction with the polyisocyanate and the polyol. Examples of the olefin-based resin include polyethylene and polypropylene.

(Aqueous Medium)

The ink may contain water or an aqueous medium that is a mixed solvent of water and a water-soluble organic solvent. As the water, deionized water or ion-exchanged water is preferably used. The content (mass %) of the water in the aqueous ink is preferably 50.0 mass % or more to 95.0 mass % or less with respect to the total mass of the ink. In addition, the content (mass %) of the water-soluble organic solvent in the aqueous ink is preferably 3.0 mass % or more to 50.0 mass % or less with respect to the total mass of the ink. As the water-soluble organic solvent, any of those usable for ink for ink jet, such as alcohols, (poly)alkylene glycols, glycol ethers, nitrogen-containing compounds and sulfur-containing compounds, may be used.

(Other Additives)

The ink may contain, in addition to the above-mentioned components, various additives, such as an antifoaming agent, a surfactant, a pH adjuster, a viscosity modifier, a corrosion inhibitor, a preservative, an antifungal agent, an antioxidant and a reduction inhibitor, as required.

Prior to the application of the ink for ink jet, such a reaction liquid as described below may be applied. The reaction liquid can be expected not only to improve image quality, but also to facilitate the prevention of the incorporation of the content to be released into pores by virtue of its effect of, for example, increasing the size of the content to be released or increasing the viscosity thereof, at the time of contact with the liquid absorbing member.

<Reaction Liquid>

Through contact with the ink, the reaction liquid can lower the fluidity of the ink and/or part of ink composition on a printing medium or a transfer body, to thereby suppress bleeding or beading at the time of image formation due to the ink. Specifically, a reagent (also called an ink-viscosity-increasing component) contained in the reaction liquid is brought into contact with the coloring material, the resin or the like serving as part of the composition forming the ink to chemically react therewith or physically adsorb thereonto. This causes an increase in viscosity of the ink as a whole or a local increase in viscosity through the aggregation of part of the constituent components of the ink, such as the coloring material, to thereby allow the fluidity of the ink and/or part of the ink composition to be lowered. When the reaction liquid is used, the ink image is formed of a mixture of the ink and the reaction liquid.

Now, each constituent component of the reaction liquid to be applied to this embodiment is described in detail.

(Reagent)

The reaction liquid is used for aggregating a component having an anionic group (the resin, the self-dispersing pigment or the like) in the ink by being brought into contact with the ink, and contains a reagent. Examples of the reagent may include cationic components, such as a polyvalent metal ion and a cationic resin, and an organic acid.

Examples of the polyvalent metal ion include: divalent metal ions, such as Ca²⁺, Cu²⁺, Ni²⁺, Mg²⁺, Sr²⁺, Ba²⁺ and Zn²⁺; and trivalent metal ions, such as Fe³⁺, Cr³⁺, Y³⁺ and Al³⁺. In order to incorporate the polyvalent metal ion into the reaction liquid, a polyvalent metal salt formed by bonding the polyvalent metal ion and an anion (a hydrate thereof may also be adopted) may be used. Examples of the anion may include: inorganic anions, such as Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, PO₄³⁻, HPO₄²⁻ and H₂PO₄⁻; and organic anions, such as HCOO⁻, (COO⁻)₂, COOH(COO⁻), CH₃COO⁻, C₂H₄(COO⁻)₂, C₆H₅COO⁻, C₆H₄(COO⁻)₂ and CH₃SO₃⁻. When the polyvalent metal ion is used as the reagent, the content (mass %) of the polyvalent metal in the reaction liquid in terms of a salt is preferably 1.00 mass % or more to 20.00 mass % or less with respect to the total mass of the reaction liquid.

The reaction liquid containing the organic acid has a buffer capacity in an acidic region (at a pH of less than 7.0, preferably a pH of from 2.0 to 5.0), and with this, converts an anionic group of a component present in the ink into an acid form to cause aggregation. Examples of the organic acid may include: monocarboxylic acids, such as formic acid, acetic acid, propionic acid, butyric acid, benzoic acid, glycolic acid, lactic acid, salicylic acid, pyrrolecarboxylic acid, furancarboxylic acid, picolinic acid, nicotinic acid, thiophenecarboxylic acid, levulinic acid and coumaric acid, and salts thereof; dicarboxylic acids, such as oxalic acid, malonic acid, succinic acid, glutaric acid, adipic acid, maleic acid, fumaric acid, itaconic acid, sebacic acid, phthalic acid, malic acid and tartaric acid, and salts or hydrogen salts thereof tricarboxylic acids, such as citric acid and trimellitic acid, and salts or hydrogen salts thereof; and tetracarboxylic acids, such as pyromellitic acid, and salts or hydrogen salts thereof. The content (mass %) of the organic acid in the reaction liquid is preferably 1.00 mass % or more to 50.00 mass % or less.

Examples of the cationic resin may include a resin having a primary to tertiary amine structure and a resin having a quaternary ammonium salt structure. Specific examples thereof may include resins each having a structure of vinylamine, allylamine, vinylimidazole, vinylpyridine, dimethylaminoethyl methacrylate, ethyleneimine or guanidine. In order to enhance solubility in the reaction liquid, the cationic resin and an acidic compound may be used in combination, or the cationic resin may be subjected to quaternization treatment. When the cationic resin is used as the reagent, the content (mass %) of the cationic resin in the reaction liquid is preferably 1.00 mass % or more to 10.00 mass % or less with respect to the total mass of the reaction liquid.

(Component Other than Reagent)

As components other than the reagent, there may be used components similar to the aqueous medium, other additives and the like given above as components that may be used for the ink.

Of the inks for ink jet, the liquid absorbing member according to one aspect of the present disclosure may be suitably used for an ink containing water and a component capable of being cured by irradiation with an active energy ray (also called an aqueous active energy ray-curable ink). A cured product produced by the irradiation with an active energy ray is sometimes brought into a soft state containing water, and is often also increased in adhesive force. The liquid absorbing member according to this embodiment can achieve both the releasability of the content and the removability of the liquid, and hence shows a remarkable effect on such ink, thus being suitable therefor. An ink to be used in the case where ultraviolet light (UV) is used as the active energy ray is hereinafter sometimes referred to as aqueous UV-curable ink.

<Aqueous Active Energy Ray-Curable Ink>

(Hydrophilic Polymerizable Component)

The component capable of being cured by irradiation with an active energy ray (curable component) is not particularly limited, but an example thereof is an ultraviolet-curable resin. Many ultraviolet-curable resins do not dissolve in water, but as a material applicable to the aqueous ink to be suitably used for one aspect of the present disclosure, the ultraviolet-curable resin preferably has, in its structure, at least bifunctionality of ethylenically unsaturated bonds curable with ultraviolet light and a hydrophilic bonding group. Examples of the bonding group for having hydrophilicity include a hydroxy group, a carboxyl group, a phosphoric acid group, a sulfonic acid group and salts thereof, an ether bond and an amide bond.

The curable component is preferably a hydrophilic one (hereinafter referred to as hydrophilic polymerizable component). When a compound is described as hydrophilic herein, it is meant that the compound is in any one of the following states.

(1) The compound is soluble in an organic solvent miscible with water, and its organic solvent solution is water-soluble.

(2) The compound itself is non-water-soluble, but is treated into a form emulsifiable in water.

In one aspect of the present disclosure, a non-water-soluble polymerizable compound may be applied to the aqueous ink in the form of an emulsion or a dispersion by being emulsified and dispersed with a surfactant or the like or by imparting a dispersible hydrophilic group, such as an anionic group, to the structure of the polymerizable compound. Examples thereof include “BEAMSET EM-90” and “BEAMSET EM-92” manufactured by Arakawa Chemical Industries, Ltd. and “UA-7100” and “UA-W2” manufactured by Shin-Nakamura Chemical Co., Ltd. (all of which are product names).

(3) The compound is water-soluble.

In one aspect of the present disclosure, at least one kind of hydrophilic polymerizable component is preferably water-soluble. In addition, the hydrophilic polymerizable component is preferably a radically polymerizable substance. The hydrophilic polymerizable component may also be further contained in the reaction liquid.

Preferred examples of the hydrophilic polymerizable component are shown in Table 1 below.

TABLE 1-1

| Example No. | Structural formula |
|---|---|
| 1 | 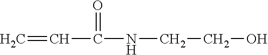 |
| 2 | 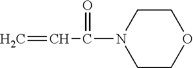 |
| 3 | 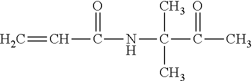 |
| 4 | 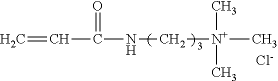 |
| 5 | 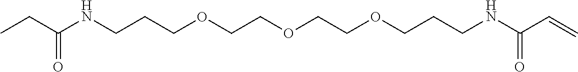 [SMILES: C=CC(=O)NCCCOCCOCCOCCCNC(=O)CC] |
| 6 | 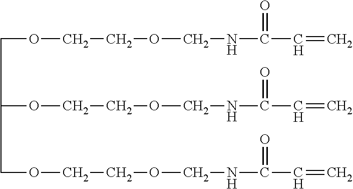 [SMILES: C=CC(=O)NCOCCOCCC(CCOCCOCNC(=O)C=C)OCCOCNC(=O)C=C] |
| 7 | 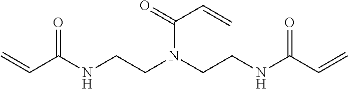 [SMILES: C=CC(=O)NCCN(CCNC(=O)C=C)C(=O)C=C] |
| 8 | 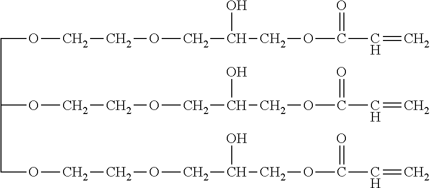 [SMILES: C=CC(=O)OCC(O)COCCOCCC(CCOCCOCC(O)COC(=O)C=C)OCCOCC(O)COC(=O)C=C] |
| 9 | 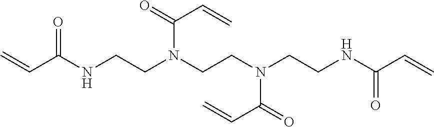 [SMILES: C=CC(=O)NCCN(CCN(CCNC(=O)C=C)C(=O)C=C)C(=O)C=C] |
| 10 | 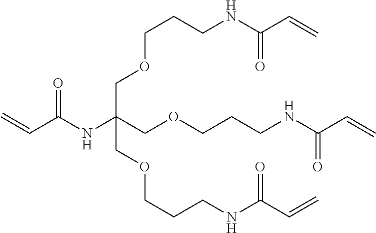 [SMILES: C=CC(=O)NCCCOCC(COCCCNC(=O)C=C)(COCCCNC(=O)C=C)NC(=O)C=C] |
| 11 | 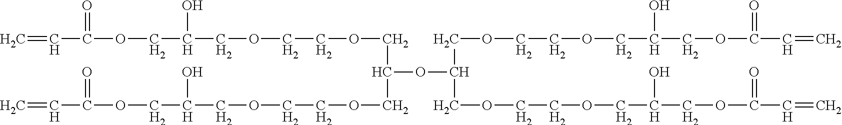 [SMILES: C=CC(=O)OCC(O)COCCOCC(COCCOCC(O)COC(=O)C=C)OC(COCCOCC(O)COC(=O)C=C)COCCOCC(O)COC(=O)C=C] |
| 12 | 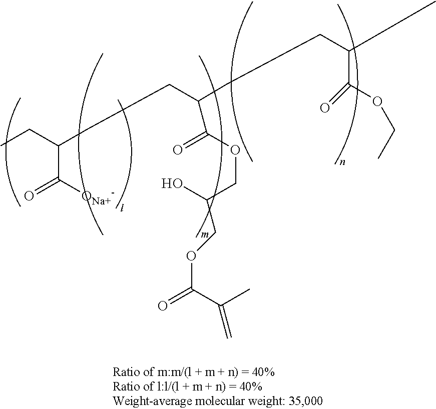 |

(Hydrophilic Polymerization Initiator)

The polymerization initiator to be used in one aspect of the present disclosure is preferably hydrophilic.

When the hydrophilic polymerizable component is a radically polymerizable substance, the hydrophilic polymerization initiator may be any compound capable of generating a radical with an active energy ray, but is preferably at least one compound selected from the group consisting of the following general formulae (7) to (11).

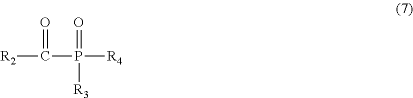

In the formula (7), R₂ represents an alkyl group or a phenyl group, R₃ represents an alkyloxy group or a phenyl group, and R₄ represents a group represented by the following formula (a).

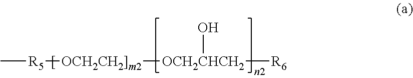

In the formula (a), R₅ represents —[CH₂]ₓ₂— (x2 represents 0 or 1) or a phenylene group, m2 represents an integer of from 0 to 10, n2 represents 0 or 1, and R₆ represents a hydrogen atom, a sulfone group, a carboxyl group or a hydroxyl group, and may form a salt.

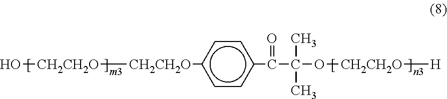

In the formula (8), m3 represents an integer of 1 or more, n3 represents an integer of 0 or more, and m3+n3 represents an integer of from 1 to 8.

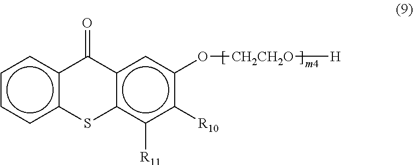

In the formula (9), R₁₀ and R₁₁ each independently represent a hydrogen atom or an alkyl group, and m4 represents an integer of from 5 to 10.

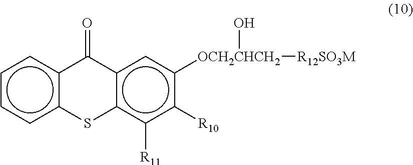

In the formula (10), R₁₀ and R₁₁ each independently represent a hydrogen atom or an alkyl group, R₁₂ represents —(CH₂), (“x” represents 0 or 1), —O—(CH₂)_{y}— (“y” represents 1 or 2) or a phenylene group, and M represents a hydrogen atom or an alkali metal.

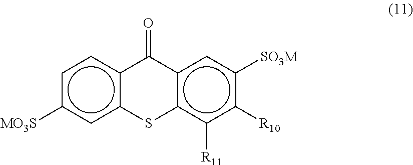

In the formula (11), R₁₀ and R₁₁ each independently represent a hydrogen atom or an alkyl group, and M represents a hydrogen atom or an alkali metal.

Of those, a compound represented by any one of the general formulae (7), (8) and (9) is preferred, and a compound represented by any one of the general formulae (7) and (8) is particularly preferred.

The alkyl group and phenyl group of R₂ in the general formula (7) may each have a substituent. Examples of such substituent include the following. Specifically, there are given, for example, a halogen, a lower alkyl group having 1 to 5 carbon atoms, a lower alkyloxy group having 1 to 5 carbon atoms, the group represented by the formula (a), a sulfone group, a carboxyl group and a hydroxyl group. R₂ particularly preferably represents a phenyl group having a lower alkyl group having 1 to 5 carbon atoms as a substituent.

The phenylene group of R₅ in the formula (a) may be any of 1,2-phenylene, 1,3-phenylene and 1,4-phenylene, and may have a substituent. Examples of such substituent include the following. Specifically, there are given, for example, a halogen, a lower alkyl group having 1 to 5 carbon atoms, a lower alkyloxy group having 1 to 5 carbon atoms, a sulfone group, a carboxyl group and a hydroxyl group.

In the case where R₂ in the general formula (7) or the phenylene group of R₅ of the formula (a) has a sulfone group, a carboxyl group or a hydroxyl group as a substituent, or in the case of the sulfone group, carboxyl group or hydroxyl group of R₆ in the formula (a), a salt may be formed. As a cation for forming such salt, there is given: a salt with a monovalent cation, such as an alkali metal cation or an ammonium cation represented by HN⁺R₇R₈R₉ (R₇, R₈ and R₉ each independently represent a hydrogen atom, a lower alkyl group having 1 to 5 carbon atoms, a monohydroxyl-substituted lower alkyl group having 1 to 5 carbon atoms or a phenyl group.); or a case in which a divalent cation, such as an alkaline earth metal cation, forms a salt with two groups each selected from a sulfone group, a carboxyl group and a hydroxyl group.

The alkyloxy group and phenyl group of R₃ in the general formula (7) may each have a substituent, and examples of such substituent include a halogen, a lower alkyl group having 1 to 5 carbon atoms and a lower alkyloxy group having 1 to 5 carbon atoms. R₃ particularly preferably represents an alkyloxy group, especially one of —OC₂H₅ and OC(CH₃)₃.

The alkyl group of each of R₁₀ and R₁₁ in the general formulae (9) to (11) may have a substituent. Examples of such substituent include the following. Specifically, there are given, for example, a halogen, a sulfone group, a carboxyl group, a hydroxyl group and a sulfone group, a carboxyl group and a hydroxyl group. When the substituent is a sulfone group, a carboxyl group or a hydroxyl group, such a salt as described in the general formula (7) may be formed.

Particularly preferred specific examples of those hydrophilic polymerization initiators include hydrophilic polymerization initiators having structures shown in Table 2 below, but the hydrophilic polymerization initiator to be used in one aspect of the present disclosure is not limited thereto.

TABLE 2

| Exemplary | |
|---|---|
| compound | |
| No. | Structural formula |
| PI-1 | 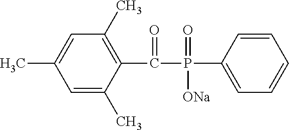 |
| PI-2 | 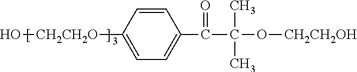 |
| PI-3 | 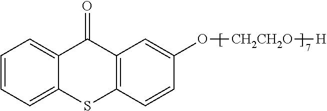 |
| PI-4 | 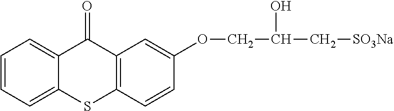 |
| PI-5 | 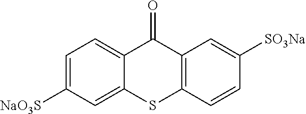 |

When a thioxanthone-based hydrophilic polymerization initiator or the like is used as the hydrophilic polymerization initiator, a hydrogen-donating agent is preferably added. Examples of the hydrogen-donating agent include, but not limited to, triethanolamine and monoethanolamine.

In addition, two or more kinds of hydrophilic polymerization initiators may be used in combination. When two or more kinds of hydrophilic polymerization initiators are added, further generation of radicals can be expected through the utilization of light having a wavelength that cannot be effectively utilized with one kind of hydrophilic polymerization initiator. In addition, the hydrophilic polymerization initiator as described above is not always required in the case where an electron beam curing method involving curing the ink through the use of an electron beam as the active energy ray is adopted.

In addition, it is preferred that an active energy ray curing catalyst to be used in combination with the component capable of being cured by irradiation with an active energy ray have a skeleton such as an α-hydroxy ketone, benzyl ketal, an acylphosphine or thioxanthone, and be hydrophilic so as to fully exhibit reactivity. As a bonding group for having hydrophilicity, there are given, for example, a hydroxy group, a carboxyl group, a phosphoric acid group, a sulfonic acid group and salts thereof, an ether bond and an amide bond, any of which may be suitably used. A material to be used in one aspect of the present disclosure is preferably dissolved in water at 1 wt % or more.

Further, combined use of a sensitizer having a function of expanding light absorption wavelengths for improving a reaction rate is also a preferred mode.

The ink to be used is not particularly limited except that the ink contains the coloring material and the hydrophilic polymerizable component. In some cases, the ink may be used as a transparent ink without the incorporation of a colorant. As the colorant, a dye or a pigment or a dispersion thereof is generally suitably used.

The dye is not limited, and a dye that is generally used may be used without any problem. Examples thereof include: C.I. Direct Blue 6, 8, 22, 34, 70, 71, 76, 78, 86, 142 and 199; C.I. Acid Blue 9, 22, 40, 59, 93, 102, 104, 117, 120, 167 and 229; C.I. Direct Red 1, 4, 17, 28, 83 and 227; C.I. Acid Red 1, 4, 8, 13, 14, 15, 18, 21, 26, 35, 37, 249, 257 and 289; C.I. Direct Yellow 12, 24, 26, 86, 98, 132 and 142; C.I. Acid Yellow 1, 3, 4, 7, 11, 12, 13, 14, 19, 23, 25, 34, 44 and 71; C.I. Food Black 1 and 2; and C.I. Acid Black 2, 7, 24, 26, 31, 52, 112 and 118.

The pigment is not limited, and a pigment that is generally used may be used without any problem. Examples thereof include: C.I. Pigment Blue 1, 2, 3, 15:3, 16 and 22; C.I. Pigment Red 5, 7, 12, 48 (Ca), 48 (Mn), 57 (Ca), 112 and 122; C.I. Pigment Yellow 1, 2, 3, 13, 16 and 83; Carbon Black Nos. 2300, 900, 33, 40, 52, MA7, MA8 and MCF88 (manufactured by Mitsubishi Kasei Corporation); RAVEN 1255 (manufactured by Columbia); REGAL 330R and 660R and MOGUL (Cabot Corporation); and Color Black FW1, FW18, S170 and S150 and Printex 35 (Degussa AG).

As a dispersing resin, a water-soluble one having a weight-average molecular weight of from about 1,000 to about 15,000 is suitably used. Examples thereof include block copolymers or random copolymers formed of styrene and derivatives thereof, vinylnaphthalene and derivatives thereof, an aliphatic alcohol ester of an α,β-ethylenically unsaturated carboxylic acid, acrylic acid and derivatives thereof, maleic acid and derivatives thereof, itaconic acid and derivatives thereof and fumaric acid and derivatives thereof, and salts thereof. In addition, a photocurable resin may also be used alone without using the dispersing resin.

In addition, the present disclosure is not limited in terms of the form of the ink, and a self-dispersing type, a resin dispersion type, a microcapsule type or the like may also be appropriately used.

The ink may contain an organic solvent in order to control an ink jet ejection property and a drying property. The organic solvent to be used is preferably a water-soluble material having a high boiling point and a low vapor pressure. Examples thereof include polyethylene glycol, polypropylene glycol, ethylene glycol, propylene glycol, butylene glycol, triethylene glycol, thiodiglycol, hexylene glycol, diethylene glycol, ethylene glycol monomethyl ether, diethylene glycol monomethyl ether and glycerin. In addition, any of alcohols, such as ethyl alcohol and isopropyl alcohol, and various surfactants may also be added as a component for adjusting a viscosity, a surface tension or the like.

A blending ratio is also not limited, and may be adjusted within a range in which ejection can be performed based on the selected ink jet printing system, the ejection force of a head, a nozzle diameter and the like. The blending ratio is generally as follows with respect to the total mass of the ink: 0.1 mass % to 10 mass % of the coloring material, 0.1 mass % to 10 mass % of the resin, 3 mass % to 40 mass % of the hydrophilic polymerizable component, 0 mass % to 10 mass % of the hydrophilic polymerization initiator, 0 mass % to 10 mass % of the solvent, 0.1 mass % to 10 mass % of the surfactant and the balance of pure water.

The liquid absorbing member according to this embodiment is brought into contact with an ink image applied to a printing medium or a transfer body to remove at least part of a liquid component (e.g., the solvent contained in the ink or in the reaction liquid) in the ink image. A method for the contact with the ink image is not limited, but for example, the following method may be used.

In order to ensure the contact with the ink image, the liquid absorbing member may be pressed against the ink image with a pressure P. Suction may be performed through the pores of the liquid absorbing member, and in this case, the pressure P is a pressure obtained by totaling the pressure of the liquid absorbing member against the printing medium or the transfer body and a suction pressure.

The content to be released is generally a viscoelastic body, and an adhesive force P3 per unit area to be generated between the liquid absorbing member and the content to be released is not always determined by only the material releasability of the liquid absorbing member. As P increases, wetting to the liquid absorbing member and permeation into its pores increase, and hence P3 increases. In order to effectively allow the content to be released to remain on the printing medium or the transfer body, it is appropriate that P3 be smaller than an aggregation force P2 per unit area of the content to be released, and be smaller than an adhesive force P1 per unit area to be generated between the content to be released and the printing medium or the transfer body.

P3<P2 and P3<P1 (A)

In addition, in order for the liquid absorbing member to satisfactorily remove the liquid component, it is appropriate that P satisfy the following relationship with a capillary pressure Ps of the ink solvent with respect to the liquid absorbing member (the direction of sucking is positive).

−Ps<P (B)

That is, even when the liquid component has a property of being repelled by the liquid absorbing member, the application of P as a pressing or suction pressure suffices. When the liquid component has a property of permeating the liquid absorbing member, the liquid absorbing member only needs to be brought into contact with the ink image, and P may be 0.

In addition, in the case where P2 is particularly small or Ps is particularly small, even when the liquid component has a property of being repelled by the liquid absorbing member, the liquid component is sometimes separated in the ink image to adhere to the liquid absorbing member.

P1 and P3 may each be measured with a general tacking tester. P2 may be measured from the maximum stress at a time when deformation is applied with a general rheometer. However, in principle, when P2 is smaller than P1, separation occurs in the content to be released during a tacking test, and hence P1 cannot be measured. When separation occurs in the content to be released, it is assumed that P2<P1. The same applies to the relationship between P2 and P3.

P may be measured with a general pressure sensor. Ps may be measured by a known method, such as a capillary rise method. However, for only the positive or negative sign of Ps, it is appropriate to simply observe whether or not the liquid permeates the liquid absorbing member.

As described above, in order to allow the liquid removal method according to one aspect of the present disclosure to more effectively function, it is required to apply pressing to the liquid absorbing member and to specially design its pressure. This indicates that the liquid removal method is distinctly different from, for example, a simple filter.

The permeation of a liquid into paper or the like is generally expressed by the Lucas-Washburn equation, and the following Olsson-Pihl's equation (C) is known as an equation obtained by further taking pressure into consideration.

$$l = \sqrt{\frac{2 r {γ}_{L} cos θ + {pr}^{2}}{4 η} t} \qquad ( C )$$

In the equation, “l” represents a permeation depth, “r” represents the radius of a pore diameter, γ_{L} represents the surface tension of the liquid, “θ” represents a contact angle, “p” represents pressure, “η” represents the viscosity of the liquid, and “t” represents time. The first term of the numerator in the square root represents a capillary force, and the second term thereof represents a force based on the pressure.

In order to release the content through more effective use of the hydrophilic and oil-repellent property of the liquid absorbing member according to one aspect of the present disclosure, it is appropriate that the force based on the pressure be smaller than the capillary force by which the content to be released is sucked to the liquid absorbing member as shown in the following expression (D). This is because material selectivity acts in the capillary force, but is absent in the force based on the pressure.

pr²<2rγ_{L} cos θ (D)

Assuming the moment at which the liquid absorbing member starts to be brought into contact with the ink image, the content to be released contained in the ink image also contains a large amount of a liquid component, in particular, water. Therefore, it is assumed that γL is 73 mN/m, which is the surface tension of water at 18° C., and cos θ is 1 with “θ” being sufficiently small. In view of the foregoing, the pressure P for allowing the hydrophilic and oil-repellent property to effectively function preferably satisfies a relationship shown in the following conditional expression (E) with the radius “r” of the pore diameter of the liquid absorbing member.

P[Pa]<1.46×10⁻¹ [N/m]/r[m] (E)

For example, assuming a liquid absorbing member having a pore diameter of 200 nm, the radius “r” of the pore diameter is 100 nm, and hence P<1.46 MPa. The actual permeation depth “l” is related to the viscosity “η” and the contact time “t”. However, when the above-mentioned condition is satisfied, the effect of the hydrophilic and oil-repellent property can be easily manifested.

A liquid removal method, an image forming method and an image forming apparatus each using the liquid absorbing member as described above are described in detail by taking an ink jet printing apparatus as an example. It should be noted that configurations, structures, materials, settings and the like should be changed as appropriate for various conditions under which the invention is applied, and are not intended to limit the scope of the present disclosure.

<Ink Jet Printing Apparatus>

Examples of the ink jet printing apparatus to which one aspect of the present disclosure is applied include: a direct drawing type ink jet printing apparatus configured to form an image directly on a printing medium; and a transfer type ink jet printing apparatus configured to form an image on a transfer body and then transfer the image onto a printing medium. An object to which an ink is applied from an ink applying device is referred to as “ink receiving medium”. The printing medium corresponds thereto in the direct drawing type ink jet printing apparatus, and the transfer body corresponds thereto in the transfer type ink jet printing apparatus.

First, devices common to both the ink jet printing apparatus are described.

<Ink Applying Device>

An ink jet head is used as an ink applying device configured to apply an ink. Examples of the ink jet head include: an ink jet head configured to eject an ink by causing film boiling in the ink through the use of an electrothermal converter to form air bubbles; an ink jet head configured to eject an ink through the use of an electromechanical converter; and an ink jet head configured to eject an ink through the utilization of static electricity. In one aspect of the present disclosure, a known ink jet head may be used. Of those, particularly from the viewpoint of high-speed and high-density printing, an ink jet head utilizing an electrothermal converter is suitably used. Drawing is performed by receiving an image signal and applying a required amount of ink to each position.

The ink jet printing apparatus according to one aspect of the present disclosure may include a plurality of ink jet heads in order to apply inks of respective colors onto the ink receiving medium. For example, when a yellow ink, a magenta ink, a cyan ink and a black ink are used to form respective color images, the ink jet printing apparatus includes four ink jet heads configured to respectively eject the four kinds of inks onto the ink receiving medium. In addition, the ink applying device may include an ink jet head configured to eject an ink containing no coloring material (clear ink).

<Reaction Liquid Applying Device>

A reaction liquid applying device may be any device capable of applying the reaction liquid onto the ink receiving medium, and any of hitherto known various devices may be appropriately used. Specific examples thereof include a gravure offset roller, an ink jet head, a die coating device (die coater) and a blade coating device (blade coater). The application of the reaction liquid with the reaction liquid applying device may be performed before the application of the ink or after the application of the ink as long as the reaction liquid can mix (react) with the ink on the ink receiving medium.

The reaction liquid is preferably applied before the application of the ink. When the reaction liquid is applied before the application of the ink, at the time of image printing by an ink jet system, bleeding, in which adjacently applied inks mix with each other, and beading, in which an ink that has previously landed is attracted to an ink that has subsequently landed, can also be suppressed. The reaction liquid applying device is not necessarily a device that is essential to the ink jet printing apparatus, and may, of course, be omitted in the case of a configuration in which the reaction liquid is not used.

Next, each of the direct drawing type ink jet printing apparatus and the transfer type ink jet printing apparatus is described. The transfer type ink jet printing apparatus includes a larger number of components, and hence is described first.

<Transfer Type Ink Jet Printing Apparatus>

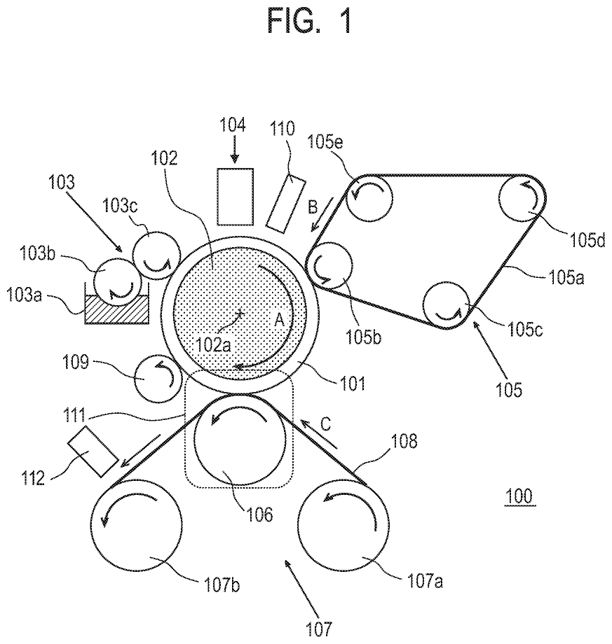

FIG. 1 is a schematic view for illustrating an example of the schematic configuration of the transfer type ink jet printing apparatus according to this embodiment. As illustrated in FIG. 1, a transfer type ink jet printing apparatus 100 includes: a transfer body 101 supported by a support member 102; a reaction liquid applying device 103 configured to apply a reaction liquid onto the transfer body 101; an ink applying device 104 configured to apply an ink onto the transfer body 101 having the reaction liquid applied thereto to form an image on the transfer body 101; a liquid absorbing device 105 configured to absorb a liquid component from the image on the transfer body 101; and a transfer section 111 including a pressing member 106 for transfer configured to transfer the image on the transfer body 101 from which the liquid component has been removed onto a printing medium 108, such as paper. In addition, the transfer type ink jet printing apparatus 100 may include, as required, a transfer body-cleaning member 109 configured to clean the surface of the transfer body 101 after transfer has been performed. The reaction liquid applying device 103 is not necessarily an essential device, and may, of course, be omitted in the case of a configuration in which the reaction liquid is not used. Between the ink applying device 104 and the liquid absorbing device 105, a device configured to radiate an active energy ray, such as an active energy ray irradiation device 110, may be arranged. The active energy ray irradiation device 110 is not necessarily an essential device, and besides, its installation position is not limited to the illustrated position. The details thereof are described later.

The support member 102 is configured to rotate in the direction of an arrow A of FIG. 1 about a rotation axis 102a thereof. The rotation of the support member 102 moves the transfer body 101. The reaction liquid and the ink are sequentially applied onto the moved transfer body 101 by the reaction liquid applying device 103 and the ink applying device 104, respectively, to form an image on the transfer body 101. The image formed on the transfer body 101 is moved by the movement of the transfer body 101 to a position at which the image is brought into contact with a liquid absorbing member 105a included in the liquid absorbing device 105.

The transfer body 101 and the liquid absorbing device 105 are moved in synchronization with each other, and the image goes through a state of being brought into contact with the liquid absorbing member 105a. During the contact, the liquid absorbing member 105a removes the liquid component from the image. At this time, the image and the liquid absorbing member 105a are preferably brought into a state of being in contact with each other with a predetermined pressing force.

The image from which the liquid component has been removed is moved by the movement of the transfer body 101 to the transfer section 111, in which the image is brought into contact with the printing medium 108, and is brought into pressure contact with the printing medium 108 conveyed to the transfer section by a printing medium conveying device 107. Thus, the image is formed on the printing medium 108.

The image is formed on the transfer body 101 by applying the ink after the application of the reaction liquid, and hence, in a non-image region, the reaction liquid remains without reacting with the ink. In this apparatus, the liquid absorbing member 105a is brought into contact with not only the image but also the unreacted reaction liquid to remove the liquid component of the reaction liquid as well. Therefore, although the foregoing description uses the expression that the liquid component is removed from the image, the expression is used not in a limitative meaning that the liquid component is removed only from the image, but in a meaning that the liquid component only needs to be removed at least from the top of the transfer body 101.

The liquid component is not particularly limited as long as the liquid component does not have a fixed shape, has fluidity, and has a nearly constant volume. Examples of the liquid component include the water and organic solvent contained in the ink and the reaction liquid.

Each component of the transfer type ink jet printing apparatus 100 is described below.

<Transfer Body>

The transfer body 101 has a surface layer including an image forming surface. As a material for the surface layer, any of various materials, such as a resin and a ceramic, may be appropriately used. Of those, a material having a high compressive modulus of elasticity is preferred in terms of durability and the like. Specific examples thereof include an acrylic resin, an acrylic silicone resin, a fluorine-containing resin and a condensate obtained by condensing a hydrolyzable organosilicon compound. In order to improve the wettability of the reaction liquid, transferability and the like, the material may be subjected to surface treatment before use. Examples of the surface treatment include flame treatment, corona treatment, plasma treatment, polishing treatment, roughening treatment, active energy ray irradiation treatment, ozone treatment, surfactant treatment and silane coupling treatment. Those treatments may be used in combination thereof. In addition, the surface layer may be provided with an arbitrary surface shape.

In addition, the transfer body 101 preferably has a compressive layer having a function of absorbing a pressure fluctuation. When the compressive layer is arranged, the compressive layer absorbs deformation to disperse a local pressure fluctuation in response to the fluctuation, and hence satisfactory transferability can be maintained even at the time of high-speed printing. As a material for the compressive layer, there are given, for example, an acrylonitrile-butadiene rubber, an acrylic rubber, a chloroprene rubber, a urethane rubber and a silicone rubber. A product obtained as follows is preferred: at the time of the molding of the above-mentioned rubber material, predetermined amounts of a vulcanizing agent, a vulcanization accelerator and the like are blended thereinto, and a foaming agent or a filler, such as hollow fine particles or sodium chloride, is further blended as required, to make the material porous. With this, air bubble portions are compressed with a volume change in response to various pressure fluctuations, and hence deformation in directions other than a compression direction is small. Accordingly, more stable transferability and durability can be obtained. As a porous rubber material, there are known one having an open-pore structure in which pores are open to each other and one having a closed-pore structure in which pores are closed to each other. In one aspect of the present disclosure, any of the structures may be adopted, and those structures may be used in combination thereof.

Further, the transfer body 101 preferably has an elastic layer between the surface layer and the compressive layer. As a material for the elastic layer, various materials, such as a resin and a ceramic, may be appropriately used. Various elastomer materials and rubber materials are preferably used in terms of processing characteristics and the like. Specific examples thereof include a fluorosilicone rubber, a phenyl silicone rubber, a fluorine rubber, a chloroprene rubber, a urethane rubber, a nitrile rubber, an ethylene propylene rubber, a natural rubber, a styrene rubber, an isoprene rubber, a butadiene rubber, an ethylene/propylene/butadiene copolymer and a nitrile butadiene rubber. Of those, a silicone rubber, a fluorosilicone rubber, and a phenyl silicone rubber are particularly preferred in terms of dimensional stability and durability because the rubbers each have a small compression set. In addition, there is little change in modulus of elasticity due to temperature, and hence the materials are also preferred in terms of transferability.

Between the layers included in the transfer body 101 (the surface layer, the elastic layer and the compressive layer), any of various adhesives or double-sided tapes may be used in order to fix/hold the layers. In addition, a reinforcing layer having a high compressive modulus of elasticity may be arranged in order to suppress lateral elongation upon mounting onto the apparatus or keep resilience. In addition, a woven fabric may be used as the reinforcing layer. The transfer body 101 may be produced as any combination of layers made of the above-mentioned materials.

The size of the transfer body 101 may be freely selected in accordance with the size of a printed image of interest. The shape of the transfer body 101 is not particularly limited, and specific examples thereof include a sheet shape, a roller shape, a belt shape and an endless web shape.

<Support Member>

The transfer body 101 is supported on the support member 102. As a method of supporting the transfer body 101, any of various adhesives or double-sided tapes may be used. Alternatively, a member for installation using a metal, a ceramic, a resin or the like as its material may be attached to the transfer body 101 to support the transfer body 101 on the support member 102 through the use of the member for installation.

The support member 102 is required to have a certain degree of structural strength from the viewpoints of its conveyance accuracy and durability. As a material for the support member, a metal, a ceramic, a resin or the like is preferably used. Of those, aluminum, iron, stainless steel, an acetal resin, an epoxy resin, polyimide, polyethylene, polyethylene terephthalate, nylon, polyurethane, silica ceramics or alumina ceramics is particularly preferably used for alleviation of inertia at the time of operation to improve control responsiveness as well as rigidity enough to withstand pressurization at the time of transfer and dimensional accuracy. In addition, it is also preferred to use those materials in combination.

<Reaction Liquid Applying Device>

The reaction liquid applying device 103 of FIG. 1 is an illustration of the case of a gravure offset roller including: a reaction liquid accommodating portion 103a configured to accommodate the reaction liquid; and reaction liquid applying members 103b and 103c configured to apply the reaction liquid present in the reaction liquid accommodating portion 103a onto the transfer body 101.

<Liquid Absorbing Device>

In this embodiment, the liquid absorbing device 105 includes the liquid absorbing member 105a and a pressing member 105b configured to press the liquid absorbing member 105a against a first image on the transfer body 101. The shapes of the liquid absorbing member 105a and the pressing member 105b are not particularly limited. For example, the following configuration may be adopted: as illustrated in FIG. 1, the pressing member 105b has a columnar shape, the liquid absorbing member 105a has a belt shape, and the liquid absorbing member 105a having a belt shape is pressed by the pressing member 105b having a columnar shape against the transfer body 101. In addition, the following configuration may be adopted: the pressing member 105b has a columnar shape, the liquid absorbing member 105a has a cylindrical shape formed on the circumferential surface of the pressing member 105b having a columnar shape, and the liquid absorbing member 105a having a cylindrical shape is pressed by the pressing member 105b having a columnar shape against the transfer body 101.

The liquid absorbing device 105 including the liquid absorbing member 105a having a belt shape may include a tensioning member configured to tension the liquid absorbing member 105a. In FIG. 1, tensioning rollers 105c, 105d and 105e serve as tensioning members. In FIG. 1, the pressing member 105b is also a roller member configured to rotate as with the tensioning rollers, but is not limited thereto.

In the liquid absorbing device 105, the liquid absorbing member 105a according to one aspect of the present disclosure is brought into contact with the image by the pressing member 105b, and thus the liquid component contained in the image is absorbed by the liquid absorbing member 105a. It is appropriate to adjust conditions such as the pressurizing force of the pressing member and a nip width between the liquid absorbing member 105a and the transfer body 101 so that the pressure P of the liquid absorbing member 105a against the image and the contact time “t” fall within the above-mentioned range. When suction is not performed through the liquid absorbing member 105a at its contact portion with the image, P is calculated by dividing the pressurizing force of the pressing member by the area of a nip. In addition, “t” is calculated by dividing the nip width by the moving speed of the transfer body 101.

As a method of reducing the liquid component in the image, in addition to this system involving bringing the liquid absorbing member 105a into contact therewith, any of various other techniques that have hitherto been used, such as a method based on heating, a method involving sending low-humidity air and a method involving reducing pressure, may be combined.

From a different perspective, the removal of the liquid component may also be described as concentrating of the ink forming the image formed on the transfer body 101. The concentrating of the ink means that the liquid component contained in the ink is reduced to increase the content ratio of a solid content, such as the coloring material and the resin, contained in the ink to the liquid component.

Then, the ink image after liquid removal, from which the liquid component has been removed, is in a state in which the ink is concentrated as compared to the ink image before liquid removal, and is further moved by the transfer body 101 to the transfer section 111, where the ink image is brought into contact with the printing medium 108 conveyed by the printing medium conveying device 107. The transfer body 101 is pressed by the pressing member 106 during the contact of the ink image after liquid removal with the printing medium 108, and thus the ink image is transferred onto the printing medium 108. The ink image after transfer, transferred onto the printing medium 108, is a reverse image of the ink image before liquid removal and the ink image after liquid removal.

In this embodiment, the image is formed on the transfer body 101 by applying the ink after the application of the reaction liquid, and hence, in the non-image region in which the image by the ink is not formed, the reaction liquid remains without reacting with the ink. In this apparatus, the liquid absorbing member 105a is brought into contact with not only the image but also the unreacted reaction liquid to remove the liquid component of the reaction liquid as well.

Therefore, although the foregoing description uses the expression that the liquid component is removed from the image, the expression is used not in a limitative meaning that the liquid component is removed only from the image, but in a meaning that the liquid component only needs to be removed at least from the image on the transfer body 101.

The liquid component is not particularly limited as long as the liquid component does not have a fixed shape, has fluidity, and has a nearly constant volume.

Examples of the liquid component include the water and organic solvent contained in the ink and the reaction liquid.

Thus, an image having a reduced liquid content is formed on the transfer body 101. The image is then transferred onto the printing medium 108 in the transfer section 111. An apparatus configuration and conditions at the time of transfer are described.

<Transfer Section>

In the transfer section 111, the image on the transfer body 101 is transferred onto the printing medium 108 conveyed by the printing medium conveying device 107 by being brought into pressure contact with the printing medium 108 by the pressing member 106 for transfer. When the image on the transfer body 101 is transferred onto the printing medium 108 after the removal of the liquid component contained therein, a printed image in which curling, cockling and the like are suppressed can be obtained.

The pressing member 106 for transfer is required to have a certain degree of structural strength from the viewpoints of conveyance accuracy and durability of the printing medium 108. As a material for the pressing member 106 for transfer, a metal, a ceramic, a resin or the like is preferably used. Of those, aluminum, iron, stainless steel, an acetal resin, an epoxy resin, polyimide, polyethylene, polyethylene terephthalate, nylon, polyurethane, silica ceramics or alumina ceramics is particularly preferably used for alleviation of inertia at the time of operation to improve control responsiveness as well as rigidity enough to withstand pressurization at the time of transfer and dimensional accuracy. In addition, those materials may also be used in combination. The shape of the pressing member 106 for transfer is not particularly limited, but an example thereof is a roller shape.

A pressure at which the image on the transfer body 101 is brought into pressure contact with the printing medium 108 and a period of time therefor only need to be appropriately adjusted in view of transferability and other conditions. In general, as the pressure increases and the period of time lengthens, followability to unevenness of the printing medium 108, such as paper, is improved to increase a real contact area, resulting in more satisfactory transferability. Meanwhile, when the pressure is excessively strong, there is an increased risk in that the texture of the paper is impaired or the durability of the transfer body 101 is impaired. In addition, as the pressure increases and the period of time lengthens, a total pressure to be applied to the pressing member increases, and hence the apparatus configuration is liable to be increased in size.

A temperature at which the image on the transfer body 101 is brought into pressure contact with the printing medium 108 is also not particularly limited, but when the temperature is equal to or higher than the glass transition point of a resin component contained in the ink or equal to or higher than the softening point thereof, the transferability becomes satisfactory. In order to achieve such temperature, a heating unit configured to heat the image on the transfer body 101, the transfer body 101 and the printing medium 108 may be arranged.

<Printing Medium and Printing Medium Conveying Device>

In this embodiment, the printing medium 108 is not particularly limited, and any known printing medium may be used. An example of the printing medium 108 is an elongate product wound into a roll shape or a sheet-shaped product cut to predetermined dimensions. As a material therefor, there are given, for example, paper, a plastic film, a wood plate, a corrugated cardboard and a metal film.

In addition, in FIG. 1, the printing medium conveying device 107 configured to convey the printing medium 108 includes a printing medium feeding roller 107a and a printing medium take-up roller 107b, but only needs to be able to convey the printing medium 108 and is not particularly limited to this configuration.

<Control System>

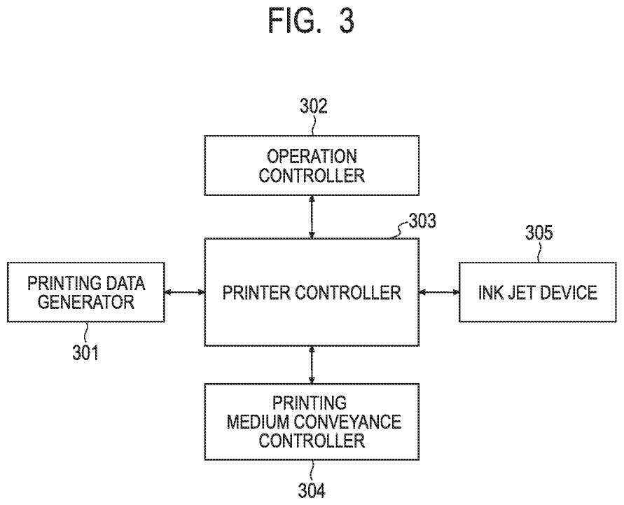

The transfer type ink jet printing apparatus 100 according to this embodiment includes a control system configured to control each device. FIG. 3 is a block diagram for illustrating a control system for the entirety of the transfer type ink jet printing apparatus 100 illustrated in FIG. 1. In FIG. 3, there are illustrated: a printing data generator 301, such as an external print server; an operation controller 302, such as an operation panel; a printer controller 303 for conducting a printing process; a printing medium conveyance controller 304 for conveying the printing medium 108; and an ink jet device 305 for performing printing.

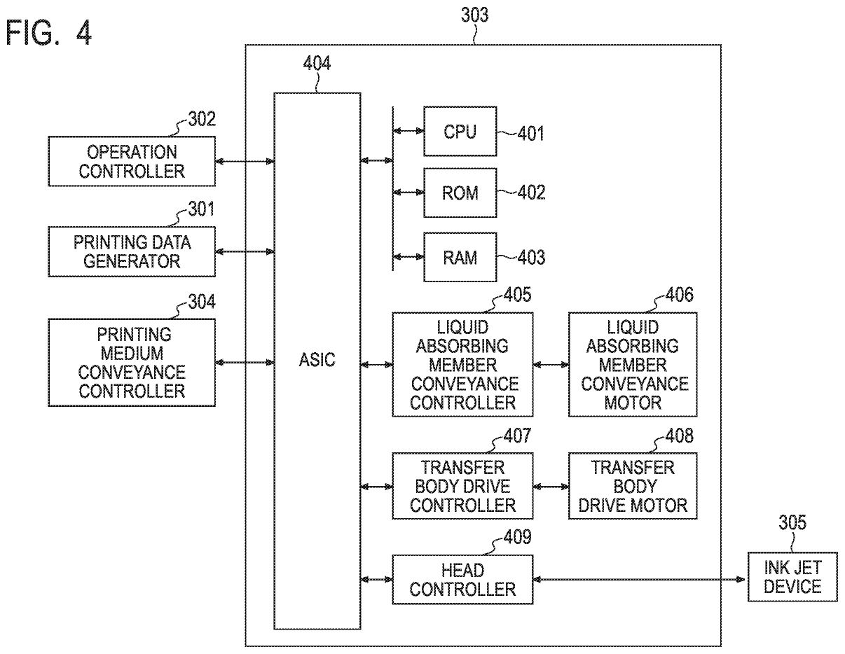

FIG. 4 is a block diagram of the printer controller in the transfer type ink jet printing apparatus 100 of FIG. 1. A CPU 401 is configured to control the entirety of a printer, a ROM 402 is configured to store the control program of the CPU, and a RAM 403 is configured to execute a program. An application specific integrated circuit (ASIC) 404 includes a network controller, a serial IF controller, a controller for head data generation, a motor controller and the like. A liquid absorbing member conveyance controller 405 is used for driving a liquid absorbing member conveyance motor 406, and is subjected to command control by the ASIC 404 via serial IF. A transfer body drive controller 407 is used for driving a transfer body drive motor 408, and is similarly subjected to command control by the ASIC 404 via serial IF. A head controller 409 is configured to, for example, generate final ejection data for the ink jet device 305 and generate a driving voltage.

<Direct Drawing Type Ink Jet Printing Apparatus>

As another embodiment of the present disclosure, there is given a direct drawing type ink jet printing apparatus 200. In the direct drawing type ink jet printing apparatus 200, the ink receiving medium is a printing medium on which an image is to be formed.

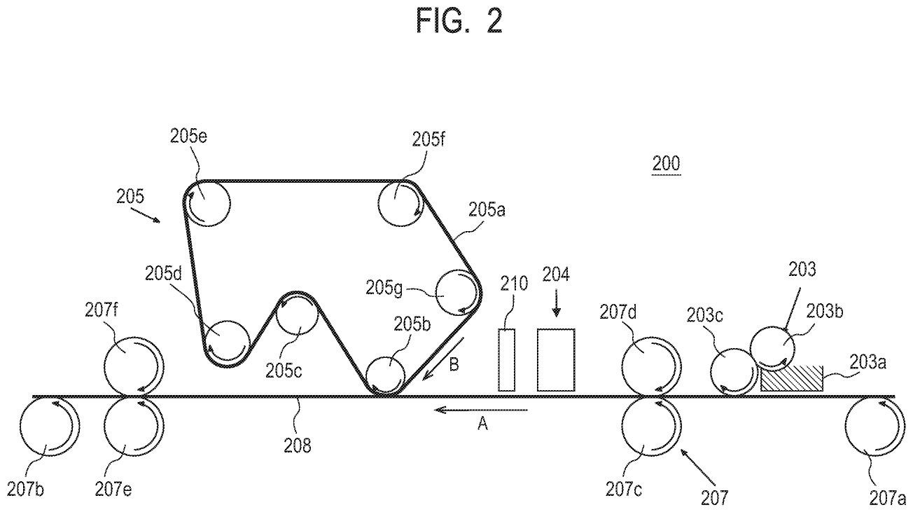

FIG. 2 is a schematic view for illustrating an example of the schematic configuration of the direct drawing type ink jet printing apparatus 200 according to this embodiment. As compared to the above-mentioned transfer type ink jet printing apparatus 100, the direct drawing type ink jet printing apparatus 200 includes the same units as those of the transfer type ink jet printing apparatus 100, except that the transfer body 101, the support member 102, the transfer body-cleaning member 109 and the transfer section 111 are absent and the image is formed on a printing medium 208.

Therefore, a reaction liquid applying device 203 configured to apply a reaction liquid to the printing medium 208, an ink applying device 204 configured to apply an ink to the printing medium 208 and a liquid absorbing device 205 configured to absorb a liquid component contained in the image with a liquid absorbing member 205a to be brought into contact with the image on the printing medium 208 have similar configurations to those in the transfer type ink jet printing apparatus 100, and hence their description is omitted.

In the direct drawing type ink jet printing apparatus 200 according to this embodiment, the liquid absorbing device 205 includes the liquid absorbing member 205a and a pressing member 205b configured to press the liquid absorbing member 205a against the image on the printing medium 208. In addition, the shapes of the liquid absorbing member 205a and the pressing member 205b are not particularly limited, and shapes similar to those of the liquid absorbing member 205a and pressing member that may be used in the transfer type ink jet printing apparatus 100 may be used. In addition, the liquid absorbing device 205 may include a tensioning member configured to tension the liquid absorbing member 205a. In FIG. 2, tensioning rollers 205c, 205d, 205e, 205f and 205g serve as tensioning members. The number of tensioning rollers is not limited to 5 of FIG. 4, and it is appropriate to arrange a required number of tensioning rollers in accordance with apparatus design. In addition, a printing section in which the ink is applied by the ink applying device 204 to the printing medium 208 and a liquid component removal section in which the liquid absorbing member 205a is brought into pressure contact with the image on the printing medium 208 to remove the liquid component may each have a printing medium support member (not shown) configured to support the printing medium 208 from below.

<Printing Medium Conveying Device>

In the direct drawing type ink jet printing apparatus 200 according to this embodiment, a printing medium conveying device 207 is not particularly limited, and a conveyance unit in a known direct drawing type ink jet printing apparatus 200 may be used. An example thereof is a printing medium conveying device 207 that includes, as illustrated in FIG. 2, a printing medium feeding roller 207a, a printing medium take-up roller 207b and printing medium conveying rollers 207c, 207d, 207e and 207f.

<Control System>

The direct drawing type ink jet printing apparatus 200 according to this embodiment includes a control system configured to control each device. A block diagram for illustrating a control system for the entirety of the direct drawing type ink jet printing apparatus 200 illustrated in FIG. 2 is as illustrated in FIG. 3 as with the transfer type ink jet printing apparatus 100 illustrated in FIG. 1.

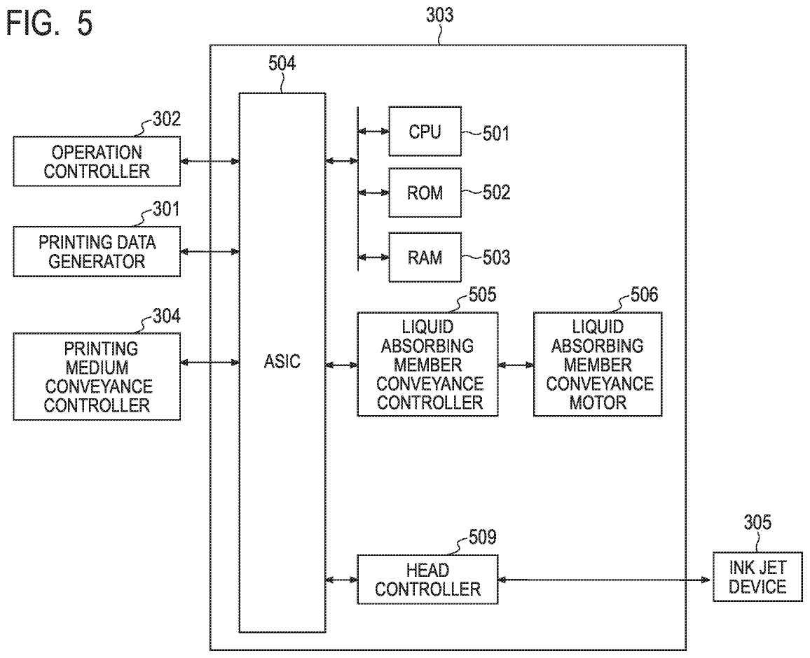

FIG. 5 is a block diagram of the printer controller in the direct drawing type ink jet printing apparatus 200 of FIG. 2. This is equivalent to the block diagram of the printer controller in the transfer type ink jet printing apparatus 100 in FIG. 4 except that the transfer body drive controller 407 and the transfer body drive motor 408 are absent. That is, a CPU 501 is configured to control the entirety of a printer, a ROM 502 is configured to store the control program of the CPU, and a RAM 503 is configured to execute a program. An ASIC 504 includes a network controller, a serial IF controller, a controller for head data generation, a motor controller and the like. A liquid absorbing member conveyance controller 505 is used for driving a liquid absorbing member conveyance motor 506, and is subjected to command control by the ASIC 504 via serial IF. A head controller 509 is configured to, for example, generate final ejection data for the ink jet device 305 and generate a driving voltage.

When an ink containing a component capable of being cured by irradiation with an active energy ray is used, the ink jet printing apparatus may include a device configured to radiate an active energy ray. When the ink contains a component capable of being cured with ultraviolet light, the ink jet printing apparatus may include an ultraviolet light irradiation device serving as an active energy ray irradiation device.

<Active Energy Ray Irradiation Device>

A known irradiation device may be used as the active energy ray irradiation device without any particular limitation as long as the irradiation device can radiate light having a wavelength that allows polymerization to proceed, such as the absorption wavelength of a polymerization initiator. Of the active energy rays, ultraviolet light is preferred. A description is hereinafter made by taking the ultraviolet light irradiation device as an example. The ultraviolet light as described herein is not limited to having a wavelength of exactly 400 nm or less, refers to light mainly having a short wavelength that allows polymerization to proceed, and includes visible light in some cases. Examples of the ultraviolet light irradiation device include a mercury lamp, a metal halide lamp, an excimer lamp and an LED.

The ultraviolet light irradiation device may be arranged at any position under any conditions depending on its role, such as pinning of the image, semi-curing or complete curing, and the position and the conditions are not particularly limited. For example, the ultraviolet light irradiation device may be arranged between heads of the ink applying device mainly for the purpose of suppressing bleeding or beading, or may be arranged with respect to the final image on the printing medium for the purpose of fixing to the printing medium or expression of fastness (hereinafter referred to as main curing).

In an ink jet printing apparatus including a liquid absorbing member as in one aspect of the present disclosure, the ultraviolet light irradiation device may be arranged (110 of FIG. 1, 210 of FIG. 2) downstream of the ink applying device and upstream of the liquid absorbing device for the purpose of, for example, the phase change or viscosity increase of the content to be released through curing with ultraviolet light. In this case, ultraviolet light irradiation may be performed under conditions under which the ink is not completely cured or is caused to stay in a semi-cured state. When brought into a semi-cured state, the cured product can be brought into a softer state, and an effect such as making transferability more satisfactory can be expected. In addition, when cured in a state of containing a large amount of water, the cured product sometimes becomes gelled. Even when water is simply removed from the gelled cured product, the fastness is insufficient in some cases. A preferred method involves first bringing the ink into a semi-cured state for its contact with the liquid absorbing member, reducing the amount of water, and then performing main curing. Therefore, the step of radiating an active energy ray preferably includes a first irradiation step of polymerizing part of the component capable of being cured by irradiation with an active energy ray contained in the ink image. In addition, the step of radiating an active energy ray more preferably includes, after the first irradiation step, a second irradiation step of polymerizing part of the component capable of being cured by irradiation with an active energy ray contained in the ink image, to thereby achieve curing.

In addition, the first irradiation step is preferably performed before the step of removing at least part of a liquid component. Further, the second irradiation step is preferably performed after the step of removing at least part of a liquid component. In particular, when the image forming method includes a transfer step, the second irradiation step is preferably performed after the transfer step. When the second irradiation step is performed after the transfer step, the ink jet printing apparatus includes, as illustrated in FIG. 1, a second active energy ray irradiation device 112 in addition to the first active energy ray irradiation device 110.

As irradiation conditions for ultraviolet light other than the wavelength, there are given an irradiance and a cumulative light quantity. The irradiance is a value representing a radiant flux per unit area, and mW/cm² is often used as its unit. The cumulative light quantity is a value representing energy per unit area obtained by integrating the irradiance with respect to time, and mJ/cm² is often used as its unit. Both the irradiance and the cumulative light quantity may be measured with a general irradiance meter adapted to ultraviolet light.

### EXAMPLES

The present disclosure is specifically described below by way of Examples and Comparative Examples. The present disclosure is by no means limited to Examples below without departing from the gist of the present disclosure. In the following, “part(s)” represents part(s) by mass and “%” represents mass %, unless otherwise stated.

A contact angle meter “CA-W” manufactured by Kyowa Interface Science Co., Ltd. was used for the measurement of a contact angle, and an extension/contraction method was used for an advancing contact angle.

### Example 1

In this Example, image formation was performed using the direct drawing type ink jet printing apparatus illustrated in FIG. 2.

Coated paper (Aurora Coat paper, basis weight: 127.9 g/m², manufactured by Nippon Paper Industries Co., Ltd.) was used as a printing medium and conveyed at a conveyance speed of 600 mm/s.

Then, a reaction liquid having the composition described below was applied with a reaction liquid applying device to the printing medium. A gravure offset roller was used as the reaction liquid applying device, and 0.6 g/m² of the following reaction liquid was applied.

(Reaction Liquid)

| | |
|---|---|
| Glutaric acid: | 50.0% |
| KOH: | 2.0% |
| Surfactant (SN-WET 125 manufactured by San Nopco Ltd., | 1.5% |
| product name): | |
| 2-Pyrrolidone: | 5.0% |
| Ion-exchanged water: | 41.5% |

Then, an ink 1 having the composition described below was applied with an ink applying device to the printing medium. An ink jet head (nozzle array density: 1,200 dpi) of a type configured to eject ink by an on-demand system with an electrothermal conversion element was used for the ink applying device and driven at a frequency of 14.173 kHz to apply 10 g/m² of the ink. The ink jet head was not one to be subjected to so-called serial scanning, and the nozzle array was fixed substantially orthogonally to the conveyance direction of the printing medium.

(Ink 1)

(Preparation of Pigment Dispersion Liquid 1) The following raw materials were mixed, and the mixture was loaded into a batch-type vertical sand mill (manufactured by AIMEX Co., Ltd.), which was filled with 200 parts of zirconia beads each having a diameter of 0.3 mm. Then, the mixture was subjected to dispersion treatment for 5 hours while being cooled with water.

| | |
|---|---|
| Pigment Red 122: | 10% |
| Resin aqueous solution (pigment dispersant): | 15% |
| Resin: styrene-acrylic acid-ethyl acrylate copolymer | |
| (acid value: 150, weight-average molecular weight: | |
| 8,000, aqueous solution having a solid content of | |
| 20%, neutralizer: KOH) | |
| Ion-exchanged water: | 75% |

Next, the resultant dispersion liquid was subjected to a centrifuge to remove coarse particles. Thus, a pigment dispersion liquid 1 having a pigment concentration of 10% was obtained.

(Water-soluble Resin 1)

A styrene-butyl acrylate-acrylic acid copolymer (acid value: 121 mgKOH/g, weight-average molecular weight 7,000, aqueous solution having a solid content of 20%, neutralizer: potassium hydroxide) was used as a water-soluble resin 1.

(Preparation of Ink 1)

The pigment dispersion liquid 1 obtained above and the water-soluble resin 1 were mixed with the following components to prepare the ink 1.

| | |
|---|---|
| Pigment dispersion liquid 1 (content of coloring | 20.0% |
| material: 10.0%) | |
| Water-soluble resin 1 | 17.0% |
| Glycerin | 7.0% |
| Surfactant | 1.0% |
| (“ACETYLENOL E100” manufactured by Kawaken | |
| Fine Chemicals Co., Ltd., product name) | |
| Ion-exchanged water | 55.0% |

Then, a liquid absorbing member 1 obtained as described below was brought into contact with the ink image on the printing medium to remove a liquid component. A pressing member was a φ100 mm roller, 10 mm of whose surface was formed of a sponge, and the liquid absorbing member was carried on its surface and pressed against the ink image at a pressure of 98 kPa (1 kgf/cm²). The nip width was 40 mm, and the contact time was 67 ms.

(Preparation of Surface Coating Material 1)

A surface coating material 1 using a fluorine compound represented by the following formula and a polyvinyl butyral resin serving as a binder, which was the same as that of Example 18 of Japanese Patent No. 5879014, was prepared.

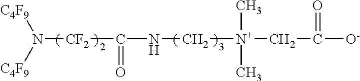

(Liquid Absorbing Member 1)

A porous PTFE film having a pore diameter of about 200 nm and a thickness of 30 μm (POREFLON (trademark) hydrophobic film HP-020-30, manufactured by Sumitomo Electric Fine Polymer, Inc.) was dipped in the surface coating material 1 and sufficiently impregnated with the solution, and then lifted, followed by drying and removal of the solvent. Thus, a liquid absorbing member 1 was obtained. The liquid absorbing member 1 immediately absorbed water, and hence its contact angle with water and advancing contact angle with water were not able to be measured. The contact angle of the liquid absorbing member 1 with n-hexadecane was 81°.

Therefore, there was prepared a product obtained by treating a flat plate of PTFE with the surface coating material 1 by the same method. The resultant flat plate had a contact angle with water of 26° and a contact angle with n-hexadecane of 67°. In addition, the advancing contact angle between the flat plate and water was 44°.

That is, the liquid absorbing member 1 was a liquid absorbing member containing a hydrophilic and oil-repellent material in at least part of the surface thereof. Further, the contact angle of the hydrophilic and oil-repellent material with water was smaller than its contact angle with n-hexadecane, and its advancing contact angle with water was less than 60°.

### Example 2

In this Example, image formation was performed under the same conditions as those of Example 1 except that a liquid absorbing member 2 obtained as described below was used.

(Preparation of Surface Coating Material 2)

A surface coating material 2 prepared using a fluorine-containing silane compound and hydrophilic silane compound represented by the following formulae, which was the same as that of Example 2 of Japanese Patent Application Laid-Open No. H05-331455, was prepared.

### Fluorine-Containing Silane Compound

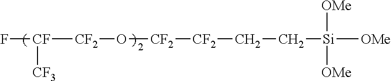

### Hydrophilic Silane Compound

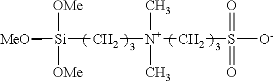

(Liquid Absorbing Member 2)

A porous PTFE film having a pore diameter of about 200 nm and a thickness of 30 μm (POREFLON (trademark) hydrophobic film HP-020-30, manufactured by Sumitomo Electric Fine Polymer, Inc.) was dipped in the surface coating material 2 and sufficiently impregnated with the solution, and then lifted, followed by drying and removal of the solvent. Next, the resultant was subjected to heat treatment at 120° C. for 2 hours. Thus, the liquid absorbing member 2 was obtained. The liquid absorbing member 2 immediately absorbed water, and hence its contact angle with water and advancing contact angle with water were not able to be measured. The contact angle of the liquid absorbing member 2 with n-hexadecane was 50°.

There was prepared a product obtained by treating a flat plate of PTFE with the surface coating material 2 by the same method. The resultant flat plate had a contact angle with water of 15° and a contact angle with n-hexadecane of 55°. In addition, the advancing contact angle between the flat plate and water was 65°.

That is, the liquid absorbing member 2 was a liquid absorbing member containing a hydrophilic and oil-repellent material in at least part of the surface thereof. In addition, the contact angle of the hydrophilic and oil-repellent material with water was smaller than its contact angle with n-hexadecane, but its advancing contact angle with water was larger than 60°.

### Comparative Example 1

In this Comparative Example, image formation was performed in the same manner as in Example 1 except that a liquid absorbing member 3 having the following configuration was used.

(Liquid Absorbing Member 3)

The liquid absorbing member 3 is a porous PTFE film having a pore diameter of 200 nm and a thickness of 30 μm (POREFLON (trademark) hydrophobic film HP-020-30, manufactured by Sumitomo Electric Fine Polymer, Inc.). The liquid absorbing member 3 had a contact angle with water of 136° and a contact angle with n-hexadecane of 29°. The liquid absorbing member 3 had an advancing contact angle with water of 162°.

The flat plate of PTFE had a contact angle with water of 105° and a contact angle with n-hexadecane of 40°. In addition, the advancing contact angle between the flat plate and water was 111°.

### Comparative Example 2

In this Comparative Example, image formation was performed in the same manner as in Example 1 except that a liquid absorbing member 4 having the following configuration was used.

(Liquid Absorbing Member 4)

The liquid absorbing member 4 is a porous hydrophilic PTFE film having a pore diameter of 200 nm and a thickness of 30 μm (POREFLON (trademark) hydrophilic film HPW-020-30, manufactured by Sumitomo Electric Fine Polymer, Inc.). This is a product obtained by treating the surface of PTFE with PVA.

The liquid absorbing member 4 had a contact angle with water of 78° and an advancing contact angle with water of 103°. n-Hexadecane was immediately absorbed and the contact angle therewith was not able to be measured.

There was prepared a product obtained by coating a flat plate of PTFE with PVA. The resultant flat plate had a contact angle with water of 36° and a contact angle with n-hexadecane of 10°. In addition, its advancing contact angle with water was 56°.

### Example 3

In this Example, image formation was performed in the same manner as in Example 1 except that: the reaction liquid was not applied; and an ink 2 having the composition described below was used. The liquid absorbing member used was the liquid absorbing member 1.

(Ink 2)

This ink is an ink for controlling glossiness, and contains no coloring material.

(Preparation of Resin Particle Dispersion Liquid 1)

18 Parts of ethyl methacrylate, 2 parts of 2,2′-azobis-(2-methylbutyronitrile) and 2 parts of n-hexadecane were mixed, and were stirred for 0.5 hour. The mixture was added dropwise to 78 parts of a 6% aqueous solution of a styrene-butyl acrylate-acrylic acid copolymer (acid value: 130 mgKOH/g, weight-average molecular weight: 7,000), and the whole was stirred for 0.5 hour. Next, the resultant was irradiated with an ultrasonic wave using an ultrasonic irradiation machine for 3 hours. Subsequently, the resultant was subjected to a polymerization reaction under a nitrogen atmosphere at 80° C. for 4 hours, cooled to room temperature, and then filtered to prepare a resin particle dispersion liquid 1 having a resin content of 40.0%. The resin particles had a weight-average molecular weight of 250,000 and an average particle diameter (D50) of 80 nm.

The glass transition point thereof was measured to be 60° C.

(Preparation of Ink 2)

The resin particle dispersion liquid 1 obtained above and the water-soluble resin 1 were used and mixed with the following components.

| | |
|---|---|
| Resin particle dispersion liquid 1 (content of | 25.0% |
| resin particles: 40.0%) | |
| Water-soluble resin 1 | 17.0% |
| Glycerin | 10.0% |
| Surfactant | 1.0% |
| (“ACETYLENOL E100” manufactured by Kawaken | |
| Fine Chemicals Co., Ltd., product name) | |
| Ion-exchanged water | 47.0% |

### Comparative Example 3

In this Comparative Example, image formation was performed in the same manner as in Example 3 except that the liquid absorbing member used was the liquid absorbing member 3.

### Comparative Example 4

In this Comparative Example, image formation was performed in the same manner as in Example 3 except that the liquid absorbing member used was the liquid absorbing member 4.

### Example 4

In this Example, image formation was performed using the transfer type ink jet printing apparatus illustrated in FIG. 1.

A transfer body having the configuration described below was used, fixed to a support member with an adhesive, and then conveyed at a conveyance speed of 600 mm/s. The surface temperature of the transfer body was adjusted to 60° C. with a heater (not shown) installed inside the support member.

(Transfer Body)

A PET sheet having a thickness of 0.5 mm was coated with a silicone rubber colored black (KE12 manufactured by Shin-Etsu Chemical Co., Ltd.) at a thickness of 0.3 mm to serve as an elastic layer. Glycidoxypropyltriethoxysilane and methyltriethoxysilane were mixed at a molar ratio of 1:1, and a mixture of a condensate obtained by heating reflux and a photocationic polymerization initiator (SP150 manufactured by ADEKA) was produced. Atmospheric-pressure plasma treatment was performed so that the surface of the elastic layer had a contact angle with water of 10° or less, and the mixture was applied onto the elastic layer, followed by UV irradiation (high-pressure mercury lamp, cumulative exposure amount: 5,000 mJ/cm²) and heat curing (150° C. for 2 hours) to form a film. Thus, the transfer body 101 having a surface layer having a thickness of 0.5 μm formed on an elastic body was produced.

Then, a reaction liquid was applied to the transfer body in the same manner as in Example 1.

Then, an ink 3 having the composition described below was applied to the transfer body by the same method under the same conditions as those of Example 1.

(Ink 3)

(Preparation of Resin Particle Dispersion Liquid 2)

20 Parts of ethyl methacrylate, 3 parts of 2,2′-azobis-(2-methylbutyronitrile) and 2 parts of n-hexadecane were mixed, and were stirred for 0.5 hour. The mixture was added dropwise to 75 parts of an 8% aqueous solution of a styrene-butyl acrylate-acrylic acid copolymer (acid value: 130 mgKOH/g, weight-average molecular weight (Mw): 7,000), and the whole was stirred for 0.5 hour. Next, the resultant was irradiated with an ultrasonic wave using an ultrasonic irradiation machine for 3 hours. Subsequently, the resultant was subjected to a polymerization reaction under a nitrogen atmosphere at 80° C. for 4 hours, cooled to room temperature, and then filtered to prepare a resin particle dispersion having a resin content of 25.0%.

(Preparation of Ink 3)

The resin particle dispersion liquid 2 and the pigment dispersion liquid 1 obtained above were mixed with the following components.

| | |
|---|---|
| Pigment dispersion liquid 1 (content of coloring | 20.0% |
| material: 10.0%) | |
| Resin particle dispersion liquid 2 | 20.0% |
| Glycerin | 7.0% |
| Polyethylene glycol (number-average molecular weight | 3.0% |
| (Mn): 1,000) | |
| Surfactant | 0.5% |
| (“ACETYLENOL E100” manufactured by Kawaken Fine | |
| Chemicals Co.Ltd., product name) | |
| Ion-exchanged water | 49.5% |

The mixture was thoroughly stirred to be dispersed, and then subjected to pressure filtration with a microfilter having a pore size of 3.0 μm (manufactured by Fujifilm Corporation) to prepare the ink 3.

Then, the liquid absorbing member 1 was brought into contact with the ink image on the transfer body to remove a liquid component. The pressing member was a φ100 mm roller, 10 mm of whose surface was formed of a sponge, and the liquid absorbing member was carried on its surface and pressed against the ink image at a pressure of 98 kPa (1 kgf/cm²). The nip width was 40 mm, and the contact time was 67 ms.

Then, the ink image was heated with an infrared irradiator (not shown). The temperature at the time of entry into the transfer section was 90° C.

Then, a printing medium was brought into pressure contact with the ink image by a pressing member for transfer to transfer the ink image from the transfer body onto the printing medium. Coated paper (Aurora Coat paper, basis weight: 127.9 g/m², manufactured by Nippon Paper Industries Co., Ltd.) was used as the printing medium and conveyed at a conveyance speed of 600 mm/s. The pressing member for transfer was a φ150 mm roller, 3 mm of whose surface was formed of a rubber, and the printing medium was pressed against the ink image at a pressure of 980 kPa (10 kgf/cm²). The nip width was 20 mm, and the contact time was 33 ms.

### Comparative Example 5

In this Comparative Example, image formation was performed in the same manner as in Example 4 except that the liquid absorbing member used was the liquid absorbing member 3.

### Comparative Example 6

In this Comparative Example, image formation was performed in the same manner as in Example 4 except that the liquid absorbing member used was the liquid absorbing member 4.

### Example 5

In this Example, image formation was performed using the transfer type ink jet printing apparatus illustrated in FIG. 1.

A transfer body similar to that of Example 4 was used, fixed to a support member with an adhesive, and then conveyed at a conveyance speed of 600 mm/s. The support member did not have a heater in the inside thereof, and the transfer body was not particularly heated.

Then, a reaction liquid was applied to the transfer body in the same manner as in Example 4.

Then, an ink 4 having the composition described below was applied to the transfer body by the same method under the same conditions as those of Example 4.

(Ink 4)

(Preparation of Ink 4)

The ink 4 was prepared according to the following composition.

| | |
|---|---|
| Pigment dispersion liquid 1: | 20.0% |
| Hydrophilic polymerizable component | 27.0% |
| (Example No. 2 in Table 1): | |
| Hydrophilic polymerizable component | 3.0% |
| (Example No. 5 in Table 1): | |
| Polymerization initiator (PI-1 in Table 2): | 4.5% |
| Surfactant: | 1.0% |
| (“ACETYLENOL EH” manufactured by Kawaken | |
| Fine Chemicals Co., Ltd., product name) | |
| Ion-exchanged water: | 44.5% |

Then, the ink image on the transfer body was irradiated with ultraviolet light through the use of a UV-LED irradiation device (UV-LED L6011, wavelength: 395 nm, manufactured by Ushio Inc.) serving as the active energy ray irradiation device 110. The cumulative light quantity was set to 400 mJ/cm². According to a preliminary investigation, the reaction had been mostly completed at this cumulative light quantity, resulting in a completely cured state. Then, a liquid component was removed from the ink image on the transfer body in the same manner as in Example 4. The liquid absorbing member used was the liquid absorbing member 1.

Then, the ink image was transferred onto a printing medium in the same manner as in Example 4.

### Comparative Example 7

In this Comparative Example, image formation was performed in the same manner as in Example 5 except that the liquid absorbing member used was the liquid absorbing member 3.

### Comparative Example 8

In this Comparative Example, image formation was performed in the same manner as in Example 5 except that the liquid absorbing member used was the liquid absorbing member 4.

### Example 6

In this Example, image formation was performed in the same manner as in Example 5 except that the conditions under which the liquid absorbing member 1 was brought into contact with the ink image were changed as described below.

The pressing member was a φ100 mm roller, 3 mm of whose surface was formed of a rubber, and the liquid absorbing member was carried on its surface and pressed against the ink image at a pressure of 980 kPa (10 kgf/cm²). The nip width was 10 mm, and the contact time was 17 ms.

### Example 7

In this Example, image formation was performed in the same manner as in Example 5 except that the conditions under which the liquid absorbing member 1 was brought into contact with the ink image were changed as described below.

The pressing member was a φ100 mm roller, 2 mm of whose surface was formed of a rubber, and the liquid absorbing member was carried on its surface and pressed against the ink image at a pressure of 1.96 MPa (20 kgf/cm²). The nip width was 10 mm, and the contact time was 17 ms.

### Example 8

In this Example, image formation was performed in the same manner as in Example 5 except that the ultraviolet light irradiation conditions of the active energy ray irradiation device were changed as described below.

Specifically, in the irradiation with ultraviolet light by the first active energy ray irradiation device 110 of FIG. 1, which was performed prior to the removal of the liquid component with the liquid absorbing member, the cumulative light quantity was set to 100 mJ/cm². According to a preliminary investigation, the reaction had not been completed at this cumulative light quantity, resulting in a semi-cured state.

Further, the ink image after having been transferred onto the printing medium was irradiated with ultraviolet light through the use of an ultraviolet light irradiation device (UV-LED L6011, wavelength: 395 nm, manufactured by Ushio Inc.) serving as the second active energy ray irradiation device 112 of FIG. 1. The cumulative light quantity was set to 400 mJ/cm².

<Evaluation>

Image formation was performed based on Examples and Comparative Examples as described above, and the releasability of an ink content and the removability of a liquid component were evaluated by such techniques as described below. For the measurement of an optical density (sometimes referred to as OD), a spectral reflection densitometer 504 manufactured by X-rite Inc. was used, and the OD of a magenta image was measured. The optical density of a liquid absorbing member or transfer body serving as a base had been measured in advance, and the value thereof was subtracted.

(Releasability of Content)

The optical density of the liquid absorbing member was measured after image formation, and evaluation was performed based on the measured value in accordance with the following criteria.

A: The OD is 0.05 or less.
B: The OD is more than 0.05 to 0.20 or less.
C: The OD is more than 0.20.

However, for each of Example 3 and Comparative Examples 3 and 4 using the ink 2 containing no coloring material, the liquid absorbing member was visually observed after image formation, and evaluation was performed in accordance with the following criteria.

A: Adhering matter is hardly present.
B: Adhering matter is present but allowable.
C: Adhering matter is present in a large amount.

(Removability of Ink Solvent (Liquid Component))

The printing medium was visually observed after image formation, and evaluation was performed in accordance with the following criteria.

A: The paper is hardly deformed.
B: The paper is slightly deformed.
C: The paper is significantly deformed.

The results of the evaluations are shown in Table 3.

TABLE 3

| | | | | | | | | Releasability of | | |
|---|---|---|---|---|---|---|---|---|---|---|
| | | | | Ultraviolet | | | | content | | |
| | | | | light | | Abutting conditions | | OD on | | |
| | | | | irradiation | Liquid | Abutting | Abutting | liquid | | |
| | | Reaction | | condition | absorbing | pressure | time | absorbing | | Removability |
| | System | liquid | Ink | (mJ/cm²) | member | (Pa) | (ms) | member | Evaluation | of ink solvent |
| Example 1 | Direct | Present | 1 | Absent | 1 | 98k | 67 | 0.05 | A | A |
| Example 2 | drawing | | | | 2 | | | 0.13 | B | A |
| Example 3 | | Absent | 2 | | 1 | | | — | B | A |
| Example 4 | Transfer | Present | 3 | | | | | 0.03 | A | A |
| Example 5 | | | 4 | 400 | | | | 0.01 | A | A |
| Example 6 | | | | | | 980k | 17 | 0.05 | A | A |
| Example 7 | | | | | | 1.96M | | 0.18 | B | A |
| Example 8 | | | | 100 | | 98k | 67 | 0.03 | A | A |
| Comparative Example 1 | Direct | Present | 1 | Absent | 3 | 98k | 67 | 0.52 | C | C |
| Comparative Example 2 | drawing | | | | 4 | | | 0.33 | C | A |
| Comparative Example 3 | | Absent | 2 | | 3 | | | — | C | C |
| Comparative Example 4 | | | | | 4 | | | — | C | A |
| Comparative Example 5 | Transfer | Present | 3 | | 3 | | | 0.46 | C | C |
| Comparative Example 6 | | | | | 4 | | | 0.22 | C | A |
| Comparative Example 7 | | | 4 | 400 | 3 | | | 0.02 | A | C |
| Comparative Example 8 | | | | | 4 | | | 1.47 | C | A |

As described above, the liquid absorbing member capable of satisfactorily removing a liquid component to be removed while alleviating the removal of a solid component, a dissolved component or a composition obtained therefrom in an ink image, which is to be left on a printing medium or a transfer body, has been able to be provided. In addition, the liquid removal method, the image forming method and the image forming apparatus each using the liquid absorbing member have been able to be provided.

According to one aspect of the present disclosure, the liquid absorbing member capable of satisfactorily removing a liquid component in an ink image, which is to be removed, while alleviating removal of a solid component, a dissolved component or a composition obtained therefrom in the ink image, which is to be left on a printing medium or a transfer body, can be provided. According to another aspect of the present disclosure, the liquid removal method, the image forming method and the image forming apparatus each using the liquid absorbing member, can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A liquid absorbing member for an image forming apparatus, the liquid absorbing member comprising a hydrophilic and oil-repellent material in at least part of a surface thereof.

2. The liquid absorbing member according to claim 1, wherein a contact angle between the hydrophilic and oil-repellent material and water is smaller than a contact angle between the hydrophilic and oil-repellent material and n-hexadecane.

3. The liquid absorbing member according to claim 1, wherein an advancing contact angle between the hydrophilic and oil-repellent material and water is 60° or less.

4. The liquid absorbing member according to claim 1, wherein the hydrophilic and oil-repellent material contains a fluorine compound having:
a hydrophilic group selected from an anionic group, a cationic group and a zwitterionic group at an end; and
one or more bonds selected from an ether bond, an amine bond, an amide bond, an ester bond and a urethane bond in a molecular chain.

5. The liquid absorbing member according to claim 1, wherein the hydrophilic and oil-repellent material contains at least one fluorine compound selected from the group consisting of the following general formulae (1) to (6):
Rf1-Rfo-Rf2-X (1)
in the general formula (1), Rf1 represents a perfluoroalkoxy group having 1 to 6 carbon atoms or a fluorine atom, Rfo represents a divalent perfluoropolyether group, Rf2 represents a linear or branched perfluoroalkylene group having 1 to 20 carbon atoms, and X represents any one hydrophilic group selected from the group consisting of an anionic group, a cationic group and a zwitterionic group;
Rf—R—X (2)
in the general formula (2), Rf represents a linear or branched perfluoroalkyl group having 6 to 16 carbon atoms, R represents a divalent organic group containing, in a linear or branched molecular chain, at least one bond selected from an ether bond, an ester bond, an amide bond and a urethane bond, and X represents any one hydrophilic group selected from the group consisting of an anionic group, a cationic group and a zwitterionic group; 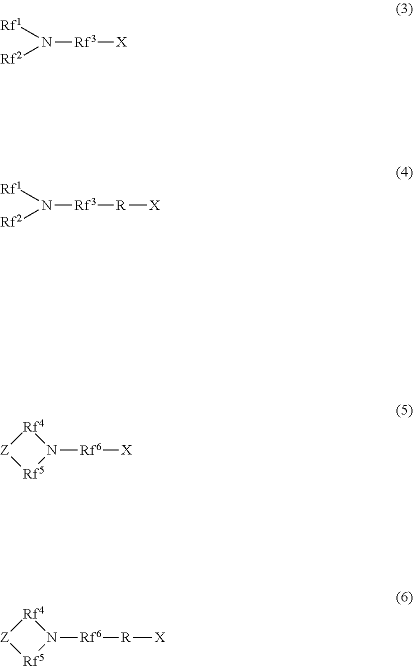
in the general formulae (3) and (4), Rf¹ and Rf² are identical to or different from each other and each represent a linear or branched perfluoroalkyl group having 1 to 6 carbon atoms, and Rf³ represents a linear or branched perfluoroalkylene group having 1 to 6 carbon atoms,
in the general formulae (5) and (6), Rf⁴, Rf⁵ and Rf⁶ are identical to or different from each other and each represent a linear or branched perfluoroalkylene group having 1 to 6 carbon atoms, and Z is selected from a divalent oxygen bond, a nitrogen bond having a substituent, a CF₂ group and a CF group having a substituent,
in the formulae (4) and (6), R represents a divalent organic group containing, in a linear or branched molecular chain, at least one selected from an ether bond, an ester bond, an amide bond and a urethane bond, and
in the general formulae (3) to (6), X represents any one hydrophilic group selected from the group consisting of an anionic group, a cationic group and a zwitterionic group.

6. A liquid removal method comprising removing at least part of a liquid component contained in an ink image formed on one of a printing medium and a transfer body by bringing the liquid absorbing member of claim 1 into contact with the ink image.

7. The liquid removal method according to claim 6, wherein the ink image is formed of an ink for ink jet.

8. The liquid removal method according to claim 6, wherein the ink image contains water and a component capable of being cured by irradiation with an active energy ray.

9. The liquid removal method according to claim 6, wherein the liquid absorbing member is pressed against the ink image at a pressure P, and the pressure P satisfies the following relationship with a radius “r” of a pore diameter of the liquid absorbing member.
P[Pa]<1.46×10⁻¹ [N/m]/r[m]

10. An image forming method comprising:
applying an ink to a printing medium to form an ink image; and
removing at least part of a liquid component contained in the ink image by bringing the liquid absorbing member of claim 1 into contact with the ink image.

11. The image forming method according to claim 10, further comprising radiating an active energy ray to the ink image.

12. The image forming method according to claim 11, wherein the radiating an active energy ray is performed before the removing at least part of a liquid component.

13. An image forming method comprising:
applying an ink to a transfer body to form an ink image;
removing at least part of a liquid component contained in the ink image by bringing the liquid absorbing member of claim 1 into contact with the ink image; and
transferring the ink image from which at least part of the liquid component has been removed, from the transfer body onto a printing medium.

14. The image forming method according to claim 13, further comprising radiating an active energy ray to the ink image.

15. The image forming method according to claim 14, wherein the radiating an active energy ray is performed before the removing at least part of a liquid component.

16. An image forming apparatus comprising:
an ink applying device configured to form an ink image on a printing medium; and
a liquid absorbing device including a liquid absorbing member,
wherein the liquid absorbing member contains a hydrophilic and oil-repellent material in at least part of a surface thereof.

17. The image forming apparatus according to claim 16, further comprising a device configured to radiate an active energy ray.

18. An image forming apparatus comprising:
a transfer body;
an ink applying device configured to form an ink image on the transfer body;
a liquid absorbing device including a liquid absorbing member; and
a transfer device configured to transfer the ink image from the transfer body onto a printing medium,
wherein the liquid absorbing member contains a hydrophilic and oil-repellent material in at least part of a surface thereof.

19. The image forming apparatus according to claim 18, further comprising a device configured to radiate an active energy ray.
